(19) United States
(12) Patent Application Publication
(10) Pub. No.: US 2020/0270534 A1
(43) Pub. Date: Aug. 27, 2020

(54) HYDROCRACKING PROCESSES USING A METAL-CALIXARENE BASED CATALYST

(71) Applicant: King Fahd University of Petroleum and Minerals, Dhahran (SA)

(72) Inventors: Mohammad Mozahar HOSSAIN, Dhahran (SA); Md. Hasan ZAHIR, Dhahran (SA); Tareq Ali Salem AL-ATTAS, Dhahran (SA)

(73) Assignee: King Fahd University of Petroleum and Minerals, Dhahran (SA)

(21) Appl. No.: 16/282,398

(22) Filed: Feb. 22, 2019

(51) Int. Cl. C10G 47/02; C10G 47/26; B01J 31/06

(52) U.S. Cl. CPC C10G 47/02; C10G 47/26; B01J 31/066; C10G 2300/70; C10G 2300/202; C10G 2400/08; C10G 2400/30; B01J 2531/845; B01J 2531/847; C10G 2400/02; C10G 2300/1077

(57) ABSTRACT

A method of utilizing a catalytic complex having a transition metal (e.g. nickel, cobalt) ion coordinated to a calixarene ligand in upgrading hydrocarbon feedstocks containing C₂₀ through C₅₀ hydrocarbons (e.g. vacuum gas oil) to produce light petroleum products (e.g. medium distillate, naphtha) is specified. A method of using the catalytic complex with a supported co-catalyst to synergistically hydrocrack the feedstocks is also provided.

### STATEMENT REGARDING PRIOR DISCLOSURE BY THE INVENTORS

Aspects of this technology are described in articles titled “Kinetics of the synergy effects in heavy oil upgrading using novel Ni-p-tert-butylcalix[4]arene as a dispersed catalyst with a supported catalyst” published in Fuel Processing Technology, 2019, Volume 185, pp 158-168, on Dec. 26, 2018, and “Novel (Co-,Ni)-p-tert-Butylcalix[4]arenes as Dispersed Catalysts for Heavy Oil Upgrading: Synthesis, Characterization, and Performance Evaluation” published in Energy & Fuels, 2019, Volume 33, pp 561-571, on Dec. 17, 2018, which are each incorporated herein by reference in their entirety.

### BACKGROUND OF THE INVENTION

### Technical Field

The present disclosure relates to methods for hydrocracking heavy hydrocarbon feedstocks into valuable light petroleum products such as medium distillate and naphtha using a catalytic system having a transition metal-calixarene complex, products obtained therefrom and corresponding catalyst compositions.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The growing demand for clean lighter fuels and light crude oil prompted petroleum refining industries to increase production of feedstocks such as residual oils, fuel oil, and bitumen [Eia. Annual Energy Outlook 2017 with projections to 2050, 2017]. In this regard, hydrocracking has become an essential technology for upgrading low-value feedstocks into high-value light products [Kandiyoti R. Hydroprocessing of heavy oils and residua. J Energy Inst 2008; 81:184-184; Angeles M J, Leyva C, Ancheyta J, Ramirez S. A review of experimental procedures for heavy oil hydrocracking with dispersed catalyst. Catal Today 2014; 220-222:274-94; and Sahu R, Song B J, Im J S, Jeon Y P, Lee C W. A review of recent advances in catalytic hydrocracking of heavy residues. J Ind Eng Chem 2015; 27:12-24]. Among numerous hydrocracking technologies, slurry phase hydrocracking is considered as one of the most versatile approaches in processing heavy feedstocks [Huc A. HEAVY CRUDE From Geology to Upgrading. 2011; and Chianelli R R, Siadati M H, De la Rosa M P, Berhault G, Wilcoxon J P, Bearden R, et al. Catalytic Properties of Single Layers of Transition Metal Sulfide Catalytic Materials. Catal Rev 2006; 48:1-41]. Slurry phase hydrocracking has the ability to achieve vacuum residue oil or heavy oil conversions of more than 95% [Zhang S, Liu D, Deng W, Que G. A review of slurry-phase hydrocracking heavy oil technology. Energy and Fuels 2007; 21:3057-62]. In addition, slurry phase hydrocracking can effectively reduce coke formation, thus minimizing sediment formation and improving production efficiency. The limitation of intraparticle mass transfer between heavy hydrocarbon molecules and solid catalysts may be reduced through the slurry phase process by using catalysts with smaller particles and applying high speed agitation [Sahu R, Song B J, Im J S, Jeon Y P, Lee C W. A review of recent advances in catalytic hydrocracking of heavy residues. J Ind Eng Chem 2015; 27:12-24].

Both supported and unsupported metal catalysts can be utilized in slurry phase hydrocracking. However, supported catalysts are subjected to significant deactivation due to coke formation that causes equipment fouling and production loss [Nguyen M T, Nguyen N T, Cho J, Park C, Park S, Jung J, et al. A review on the oil-soluble dispersed catalyst for slurry-phase hydrocracking of heavy oil. J Ind Eng Chem 2016; 43:1-12]. On the other hand, dispersed catalysts with sizes similar to reactant molecules can provide high hydrogenation activities that lead to reduced coke formation and equipment fouling [Lott. HYDROPROCESSING METHOD AND SYSTEM FOR UPGRADING HEAVY OIL USING A COLLOIDAL OR MOLECULAR CATALYST, 2009; Ebullated bed hydroprocessing methods and systems and methods of upgrading an existing ebullated bed system, 2005; and Rueda N, Bacaud R, Vrinat M. Highly dispersed, nonsupported molybdenum sulfides. J Catal 1997; 169:404-6]. Furthermore, a higher surface area to volume ratio attained by dispersed catalysts may lower mass transfer limitations through shortened diffusion pathways and minimized concentration gradients in catalyst particles [Rueda N, Bacaud R, Vrinat M. Highly dispersed, nonsupported molybdenum sulfides. J Catal 1997; 169:404-6]. Dispersed catalysts can be obtained from natural ores such as limonite, magnetite, hematite, molybdenite, laterite and ferrite [Quitian A, Ancheyta J. Experimental Methods for Developing Kinetic Models for Hydrocracking Reactions with Slurry-Phase Catalyst Using Batch Reactors. Energy and Fuels 2016; 30:4419-37; U.S. Pat. No. 8,062,505 B2; and Sharypov V I, Kuznetsov B N, Beregovtsova N G, Reshetnikov O L, Baryshnikov S V. Modification of iron ore catalysts for lignite hydrogenation and hydrocracking of coal-derived liquids. Fuel 1996; 75:39-42, each incorporated herein by reference in their entirety]. Alternatively, they can be synthesized using appropriate metal precursors such as MoS₂, MoO₃, and CoS₂ [Al-Marshed A, Hart A, Leeke G, Greaves M, Wood J. Effectiveness of Different Transition Metal Dispersed Catalysts for In Situ Heavy Oil Upgrading. Ind Eng Chem Res 2015; 54:10645-55; Quitian A, Ancheyta J. Experimental Methods for Developing Kinetic Models for Hydrocracking Reactions with Slurry-Phase Catalyst Using Batch Reactors. Energy and Fuels 2016; 30:4419-37; and Furimsky E. Catalysts for Upgrading Heavy Petroleum Feeds. Stud Surf Sci Catal 2007; 1st:404, each incorporated herein by reference in their entirety].

Initially, slurry phase hydrocracking technology mainly used solid powder catalysts. For example, VEBA Combi Cracking (VCC) process [Sahu R, Song B J, Im J S, Jeon Y P, Lee C W. A review of recent advances in catalytic hydrocracking of heavy residues. J Ind Eng Chem 2015; 27:12-24; Zhang S, Liu D, Deng W, Que G. A review of slurry-phase hydrocracking heavy oil technology. Energy and Fuels 2007; 21:3057-62; and Bellussi G, Rispoli G, Landoni A, Millini R, Molinari D, Montanari E, et al. Hydroconversion of heavy residues in slurry reactors: Developments and perspectives. J Catal 2013; 308:189-200], Canadian CANMET process [Zhang S, Liu D, Deng W, Que G. A review of slurry-phase hydrocracking heavy oil technology. Energy and Fuels 2007; 21:3057-62; Bellussi G, Rispoli G, Landoni A, Millini R, Molinari D, Montanan E, et al. Hydroconversion of heavy residues in slurry reactors: Developments and perspectives. J Catal 2013; 308:189-200], HDH technology [U.S. Pat. No. 4,591,426 A], Super Oil Cracking (SOC) all used powderous solid catalysts for slurry phase processes [Chianelli R R, Siadati M H, De la Rosa M P, Berhault G, Wilcoxon J P, Bearden R, et al. Catalytic Properties of Single Layers of Transition Metal Sulfide Catalytic Materials. Catal Rev 2006; 48:1-41]. Although these technologies demonstrated a high hydrocarbon conversion, agglomeration became a major drawback.

In order to address particulate formation, oil soluble dispersed catalysts have been proposed. Homogeneously dispersed metal catalysts are categorized into two types: water-soluble dispersed catalyst and oil-soluble dispersed catalyst. The dispersed catalyst is activated by converting the metal precursor to its catalytically active sulfide form in-situ by reacting with H₂S, which is generated during hydrodesulfurization reactions [Furimsky E. Catalysts for Upgrading Heavy Petroleum Feeds. Stud Surf Sci Catal 2007; 1st:404; Du H, Li M, Liu D, Ren Y, Duan Y. Slurry-phase hydrocracking of heavy oil and model reactant: effect of dispersed Mo catalyst. Appl Petrochemical Res 2015; 5:89-98, each incorporated herein by reference in their entirety]. Furthermore, the dispersed metallic active sites are formed during upgrading as the metals detach from the organic ligands. Consequently, the hydrogenation efficiency is enhanced under upgrading conditions and the probability of deactivation is lowered.

Oil-soluble dispersed catalysts are organometallic compounds that can be prepared by coordinating metals with organic ligands including organic acids (naphthenic, acetic, oxalic, octoic, etc.), organic amines, metal-containing quaternary ammonium compounds, etc. [Furimsky E. Catalysts for Upgrading Heavy Petroleum Feeds. Stud Surf Sci Catal 2007; 1st:404, incorporated herein by reference in its entirety]. Oil soluble catalysts may provide highly dispersed metal sulfides formed in-situ because of the great solubility of organometallic compounds in heavy oil. Well dispersed catalysts can potentially provide high hydrogenation activities during heavy oil cracking [Bagheri S R, Gray M R, Shaw J M, McCaffrey W C. In situ observation of mesophase formation and coalescence in catalytic hydroconversion of vacuum residue using a stirred hot-stage reactor. Energy and Fuels 2012; 26:3167-78; Zhang S, Deng W, Luo H, Lui D, Que G. Slurry-phase residue hydrocracking with dispersed nickel catalyst. Energy and Fuels 2008; 22:3583-6; Liu D, Cui W, Zhang S, Que G. Role of dispersed Ni catalyst sulfurization in hydrocracking of residue from Karamay. Energy and Fuels 2008; 22:4165-9; and Shen R, Liu C, Que G. Hydrocracking of Liaohe vacuum residue with bimetallic oil-soluble catalysts. ACS Div Fuel Chem Prepr 1998; 43:481-3, each incorporated herein by reference in their entirety].

In view of the forgoing, one objective of the present disclosure is to provide a hydrocracking process catalyzed by a transition metal-calixarene complex for upgrading hydrocarbon feedstocks in the presence of H₂ gas. A further objective of the present disclosure is to provide a hydrocracking process synergistically catalyzed by the transition metal-calixarene complex and a supported hydrocracking catalyst.

### BRIEF SUMMARY OF THE INVENTION

According to a first aspect, the present disclosure relates to a method for hydrocracking a hydrocarbon feedstock containing C₂₀ through C₅₀ hydrocarbons that boils in a range of 300-700° C. The method involves the steps of mixing the hydrocarbon feedstock and a catalyst to form a slurry, and heating the slurry in the presence of H₂ gas thereby forming a hydrocracked product. The catalyst comprises a complex involving a transition metal ion coordinated to a calixarene ligand of formula (I)

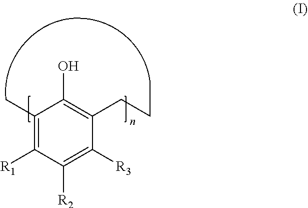

or a salt thereof, a solvate thereof, a tautomer thereof, a stereoisomer thereof, or a mixture thereof, wherein R₁, R₂, and R₃ are each independently selected from the group consisting of a hydrogen, an optionally substituted alkyl, an optionally substituted cycloalkyl, an optionally substituted alkoxy, a sulfonic acid, and a hydroxy, and n is an integer in a range of 4-8.

In one embodiment, the transition metal ion is an ion of at least one metal selected from the group consisting of Fe, Ni, Co, Mo, Ru, Rh, Pd, W, and Re.

In one embodiment, the transition metal ion is an ion of Ni, Co, or both.

In one embodiment, R₂ is a tert-butyl.

In one embodiment, R₁ and R₃ are a hydrogen.

In one embodiment, n is 4.

In one embodiment, the calixarene ligand is 4-tert-butylcalix[4]arene.

In one embodiment, the complex has an ultraviolet visible absorption with an absorption band in a range of 380-550 nm.

In one embodiment, the complex is present in the slurry at a concentration of 500-20,000 ppm.

In one embodiment, the hydrocarbon feedstock comprises vacuum gas oil (VGO).

In one embodiment, the hydrocarbon feedstock has a sulfur content of 0.5-5 wt % relative to a total weight of the hydrocarbon feedstock.

In one embodiment, the hydrocracked product comprises a middle distillate, a naphtha, or both.

In one embodiment, the slurry is heated at a temperature in a range of 350-500° C.

In one embodiment, the slurry is heated for 0.25-4 hours.

In one embodiment, a pressure of the H₂ gas is in a range of 3 to 10 MPa.

In one embodiment, the middle distillate is present in the hydrocracked product, and a yield of the middle distillate ranges from 30-55 wt % relative to a weight of the hydrocarbon feedstock.

In one embodiment, the naphtha is present in the hydrocracked product, and a yield of the naphtha ranges from 7-30 wt % relative to a weight of the hydrocarbon feedstock.

In one embodiment, the method produces coke in an amount of less than 5 wt % relative to a weight of the hydrocarbon feedstock.

In one embodiment, the catalyst further comprises a supported hydrocracking catalyst, and a weight ratio of the supported hydrocracking catalyst to the hydrocarbon feedstock ranges from 1:5 to 1:50

In one embodiment, the supported hydrocracking catalyst comprises tungsten and nickel.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exemplary reaction scheme for the synthesis of calix[n]arenes.

FIG. 2 is a scheme illustrating a setup of autoclave batch reactor.

FIG. 3A is a scanning electron microscope (SEM) image of free 4-tert-butylcalix[4]arene (TBC[4]).

FIG. 3B shows a magnified view of the SEM image of FIG. 3A.

FIG. 3C shows a magnified view of the SEM image of FIG. 3B.

FIG. 3D shows a magnified view of the SEM image of FIG. 3C.

FIG. 4A is a scanning electron microscope (SEM) image of a complex having nickel ion coordinated to TBC[4] (Ni-TBC[4]).

FIG. 4B shows a magnified view of the SEM image of FIG. 4A.

FIG. 4C shows a magnified view of the SEM image of FIG. 4B.

FIG. 4D shows a magnified view of the SEM image of FIG. 4C.

FIG. 5A is a scanning electron microscope (SEM) image of a complex having cobalt ion coordinated to TBC[4] (Co-TBC[4]).

FIG. 5B shows a magnified view of the SEM image of FIG. 5A.

FIG. 5C shows a magnified view of the SEM image of FIG. 5B.

FIG. 5D shows a magnified view of the SEM image of FIG. 5C.

FIG. 6A is an elemental mapping of carbon in complex Ni-TBC[4].

FIG. 6B is an elemental mapping of oxygen in complex Ni-TBC[4].

FIG. 6C is an elemental mapping of nickel in complex Ni-TBC[4].

FIG. 7A is an elemental mapping of carbon in complex Co-TBC[4].

FIG. 7B is an elemental mapping of oxygen in complex Co-TBC[4].

FIG. 7C is an elemental mapping of cobalt in complex Co-TBC[4].

FIG. 8 is an overlay of X-ray diffraction (XRD) patterns of Co-TBC[4], Ni-TBC[4], and free TBC[4].

FIG. 9 is an overlay of UV-vis spectra of Co-TBC[4], Ni-TBC[4], and free TBC[4].

FIG. 10 is a graph showing product yield distribution of hydrocracking VGO thermally, and using 500 ppm oil soluble cobalt (cobalt(II) 2-ethylhexanoate), oil soluble nickel (nickel(II) 2-ethylhexanoate), complex Co-TBC[4], and complex Ni-TBC[4], respectively, under H₂ pressure of 8.5 MPa at 420° C. for 1 h.

FIG. 11 is a scheme illustrating a proposed sulfidation of metal coordinated to TBC[4] and metal coordinated to 2-ethylhexanoate, respectively.

FIG. 12A is a graph showing product yield distribution of hydrocracking VGO using complex Co-TBC[4] having different concentrations of cobalt under H₂ pressure of 8.5 MPa at 420° C. for 1 h.

FIG. 12B is a graph showing product yield distribution of hydrocracking VGO using complex Ni-TBC[4] having different concentrations of nickel under H₂ pressure of 8.5 MPa at 420° C. for 1 h.

FIG. 13 is a graph is a graph showing product yield distribution of hydrocracking VGO using complex Ni-TBC[4] having 500 ppm of nickel under H₂ pressure of 8.5 MPa at 420° C. and 450° C., respectively, for 1 h.

FIG. 14 is a graph showing product yield distribution of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for 1 h.

FIG. 15 is a graph showing product yield distribution of hydrocracking VGO using a mix of the supported hydrocracking catalyst and complex Ni-TBC[4] having 500 ppm of nickel, respectively, under H₂ pressure of 8.5 MPa at 390° C., 420° C., and 450° C., respectively, for 1 h.

FIG. 16A is a graph showing VGO conversions of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for different time periods.

FIG. 16B is a graph showing I values of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for different time periods.

FIG. 16C is a graph showing middle distillate yields of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for different time periods.

FIG. 16D is a graph showing naphtha yields of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for different time periods.

FIG. 16E is a graph showing gases formations of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for different time periods.

FIG. 16F is a graph showing coke formations of hydrocracking VGO using a supported hydrocracking catalyst (KC-2710) alone, and a mix of the supported hydrocracking catalyst and complex Ni-TBC[4] having 500 ppm of nickel, respectively, under H₂ pressure of 8.5 MPa at 420° C. for different time periods.

### DETAILED DESCRIPTION OF THE EMBODIMENTS

Embodiments of the present disclosure will now be described more fully hereinafter with reference to the accompanying drawings, in which some, but not all embodiments of the disclosure are shown.

As used herein, the words “a” and “an” and the like carry the meaning of “one or more”. Within the description of this disclosure, where a numerical limit or range is stated, the endpoints are included unless stated otherwise. Also, all values and subranges within a numerical limit or range are specifically included as if explicitly written out.

As used herein, the terms “complex”, “compound”, and “product” are used interchangeably, and are intended to refer to a chemical entity, whether in the solid, liquid or gaseous phase, and whether in a crude mixture or purified and isolated.

As used herein, the term “solvate” refers to a physical association of a compound of this disclosure with one or more solvent molecules, whether organic or inorganic. This physical association includes hydrogen bonding. In certain instances, the solvate will be capable of isolation, for example when one or more solvent molecules are incorporated in the crystal lattice of the crystalline solid. The solvent molecules in the solvate may be present in a regular arrangement and/or a non-ordered arrangement. The solvate may comprise either a stoichiometric or nonstoichiometric amount of the solvent molecules. Solvate encompasses both solution phase and isolable solvates. Exemplary solvents include, but are not limited to, water, methanol, ethanol, n-propanol, iso-propanol, n-butanol, iso-butanol, tert-butanol, ethyl acetate and other lower alkanols, glycerine, acetone, dichloromethane (DCM), dimethyl sulfoxide (DMSO), dimethyl acetate (DMA), dimethylformamide (DMF), isopropyl ether, acetonitrile, toluene, N-methylpyrrolidone (NMP), tetrahydrofuran (THF), tetrahydropyran, other cyclic mono-, di- and tri-ethers, polyalkylene glycols (e.g. polyethylene glycol, polypropylene glycol, propylene glycol), and mixtures thereof in suitable proportions. Exemplary solvates include, but are not limited to, hydrates, ethanolates, methanolates, isopropanolates and mixtures thereof. Methods of solvation are generally known to those skilled in the art.

As used herein, the term “tautomer” refers to constitutional isomers of organic compounds that readily convert by tautomerization or tautomerism. The interconversion commonly results in the formal migration of a hydrogen atom or proton, accompanied by a switch of a single bond and adjacent double bond. Tautomerism is a special case of structural isomerism, and because of the rapid interconversion, tautomers are generally considered to be the same chemical compound. In solutions in which tautomerization is possible, a chemical equilibrium of the tautomers will be reached. The exact ratio of the tautomers depends on several factors including, but not limited to, temperature, solvent and pH. Exemplary common tautomeric pairs include, but are not limited to, ketone and enol, enamine and imine, ketene and ynol, nitroso and oxime, amide and imidic acid, lactam and lactim (an amide and imidic tautomerism in heterocyclic rings), and open-chain and cyclic forms of an acetal or hemiacetal (e.g., in reducing sugars).

As used herein, the term “stereoisomer” refers to isomeric molecules that have the same molecular formula and sequence of bonded atoms (i.e. constitution), but differ in the three-dimensional orientations of their atoms in space. This contrasts with structural isomers, which share the same molecular formula, but the bond connection of their order differs. By definition, molecules that are stereoisomers of each other represent the same structural isomer. Enantiomers are two stereoisomers that are related to each other by reflection, they are non-superimposable mirror images. Every stereogenic center in one has the opposite configuration in the other. Two compounds that are enantiomers of each other have the same physical properties, except for the direction in which they rotate polarized light and how they interact with different optical isomers of other compounds. Diastereomers are stereoisomers not related through a reflection operation, they are not mirror images of each other. These include meso compounds, cis- and trans- (E- and Z-) isomers, and non-enantiomeric optical isomers. Diastereomers seldom have the same physical properties. In terms of the present disclosure, stereoisomers may refer to enantiomers, diastereomers, or both.

Conformers, rotamers, or conformational isomerism refers to a form of isomerism that describes the phenomenon of molecules with the same structural formula but with different shapes due to rotations around one or more bonds. Different conformations can have different energies, can usually interconvert, and are very rarely isolatable. There are some molecules that can be isolated in several conformations. Atropisomers are stereoisomers resulting from hindered rotation about single bonds where the steric strain barrier to rotation is high enough to allow for the isolation of the conformers. In terms of the present disclosure, stereoisomers may refer to conformers, atropisomers, or both.

In terms of the present disclosure, stereoisomers of ring systems, stereogenic centers, and the like can all be present in the compounds, and all such stable isomers are contemplated in the present disclosure. S- and R- (or L- and D-) stereoisomers of the compounds of the present disclosure are described and may be isolated as a mixture of isomers or as separated isomeric forms. All processes or methods used to prepare compounds of the present disclosure and intermediates made therein are considered to be part of the present disclosure. When stereoisomeric products are prepared, they may be separated by conventional methods, for example, by chromatography, fractional crystallization, or use of a chiral agent.

As used herein, the term “alkyl” unless otherwise specified refers to both branched and straight chain saturated aliphatic primary, secondary, and/or tertiary hydrocarbons of typically C₁ to C₂₁, for example C₁, C₂, C₃, C₄, C₅, C₆, C₇, C₈, C₉, C₁₀, C₁₁, C₁₂, C₁₃, C₁₄, and specifically includes, but is not limited to, methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, 2-propylheptyl, tetradecyl, pentadecyl, hexadecyl, heptadecyl, octadecyl, nonadecyl, and eicosyl.

The term “cycloalkyl” refers to cyclized alkyl groups. Exemplary cycloalkyl groups include, but are not limited to, cyclopropyl, cyclobutyl, cyclopentyl, cyclohexyl, norbornyl, and adamantyl. Branched cycloalkyl groups such as exemplary 1-methylcyclopropyl and 2-methylcyclopropyl groups are included in the definition of cycloalkyl as used in the present disclosure.

The term “alkoxy” refers to a straight or branched chain alkoxy including, but not limited to, methoxy, ethoxy, propoxy, isopropoxy, butoxy, isobutoxy, secondary butoxy, tertiary butoxy, pentoxy, isopentoxy, hexyloxy, heptyloxy, octyloxy, nonyloxy, and decyloxy.

As used herein, the term “substituted” refers to at least one hydrogen atom that is replaced with a non-hydrogen group, provided that normal valencies are maintained and that the substitution results in a stable compound. When a substituent is noted as “optionally substituted”, the substituents are selected from the exemplary group including, but not limited to, halo, hydroxy, alkoxy, oxo, alkanoyl, aryloxy, alkanoyloxy, thiol, alkylthio, arylthio, arylalkylthio, alkylthiono, arylthiono, aryalkylthiono, alkylsulfonyl, arylsulfonyl, arylalkylsulfonyl, nitro, cyano, carboxy, carbamyl (e.g. —CONH₂), substituted carbamyl (e.g. —CONHalkyl, —CONHaryl, —CONHarylalkyl or cases where there are two substituents on one nitrogen from alkyl, aryl, or alkylalkyl), alkoxycarbonyl, aryl, substituted aryl, guanidine, heterocyclyl (e.g. indolyl, imidazoyl, furyl, thienyl, thiazolyl, pyrrolidyl, pyridyl, pyrimidiyl, pyrrolidinyl, piperidinyl, morpholinyl, piperazinyl, homopiperazinyl and the like), substituted heterocyclyl and mixtures thereof and the like. The substituents may themselves be optionally substituted, and may be either unprotected, or protected as necessary, as known to those skilled in the art, for example, as taught in Greene, et al., “Protective Groups in Organic Synthesis”, John Wiley and Sons, Second Edition, 1991, hereby incorporated by reference in its entirety.

The present disclosure is intended to include all isotopes of atoms occurring in the present compounds. Isotopes include those atoms having the same atomic number but different mass numbers. By way of general example, and without limitation, isotopes of hydrogen include deuterium and tritium, isotopes of carbon include ¹³C and ¹⁴C, isotopes of oxygen include ¹⁶O, ¹O and ¹⁸O, and isotopes of nickel include ⁵⁸Ni, ⁶⁰⁻⁶²Ni and ⁶⁴Ni. Isotopically labeled compounds of the disclosure can generally be prepared by conventional techniques known to those skilled in the art or by processes and methods analogous to those described herein, using an appropriate isotopically labeled reagent in place of the non-labeled reagent otherwise employed.

According to a first aspect, the present disclosure relates to a method for hydrocracking a hydrocarbon feedstock. The method involves the steps of mixing the hydrocarbon feedstock and a catalyst to form a slurry, and heating the slurry in the presence of H₂ gas thereby forming a hydrocracked product.

As used herein, “hydrocracking” means a process that consumes hydrogen and converts a hydrocarbonaceous feed stream, such as a petroleum fraction, to a hydrocarbon product (i.e. hydrocracked product), in which at least portions of high molecular weight compounds in the feed stream are cracked to lower boiling products.

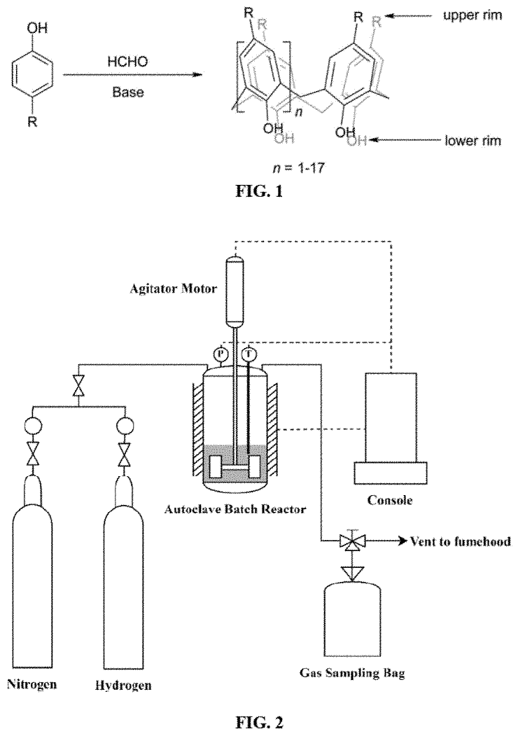

Calixarenes are macrocyclic oligomeric phenolic compounds formed via condensation reaction of para-substituted phenols in the presence of formaldehyde under alkaline conditions at a proper temperature [Ziegler A, Zinke E. Zur Kenntnis des Hartungs-prozesses von Phenol-Formaldehyd-Harzen, VII. Mitteilung. Berichte Der Dtsch Chem Gesellschaft 1909; 74:17-47; Gutsche C D, Iqbal M, Stewart D. Calixarenes. 18. Synthesis Procedures for p-tert-Butylcalix[4]arene. J Org Chem 1986; 51:742-5, each incorporated herein by reference in their entirety]. An exemplary formation reaction of calix[n]arenes (R=alkyl, n=number of p-substituted phenols) is shown in FIG. 1 [Homden D M, Redshaw C. The use of calixarenes in metal-based catalysis. Chem Rev 2008; 108:5086-130, incorporated herein by reference in its entirety].

The exemplary synthesis procedure was developed to obtain calixarenes with different configurations having tetrameric, hexameric, or octameric phenolic ring systems bridged by methylene (—CH₂—) spacers by varying reaction temperature and/or the amount of base used [Vinet L, Zhedanov A. Calixarenes 50th Anniversary: Commemorative Issue. vol. 58. 1994; and Gutsche C D (Carl D. Calixarenes: an introduction. RSC Pub; 2008, each incorporated herein by reference in their entirety]. Although this class of macromolecular compounds had been studied earlier by Baeyer and Zinke, the name was proposed by C. D. Gutsche who suggested an analogy between cyclic tetramers and a type of Greek vase known as calix crater, so it was titled as “calix[n]arene” where the n represents the number of phenolic residues involved in the structure [Gutsche C D (Carl D. Calixarenes : an introduction. RSC Pub; 2008; and Gutsche C D, Dhawan B, No K H, Muthukrishnan R. Calixarenes. 4. The Synthesis, Characterization, and Properties of the Calixarenes fromp-tert-Butylphenol. J Am Chem Soc 1981; 103:3782-92, each incorporated herein by reference in their entirety].

In preferred embodiments, the catalyst comprises a complex having a transition metal ion coordinated to a calixarene ligand of formula (I)

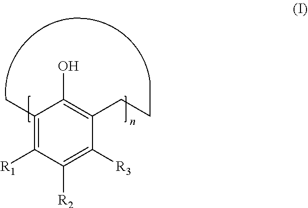

or a salt thereof, a solvate thereof, a tautomer thereof, a stereoisomer thereof, or a mixture thereof.

R₂ is selected from the group consisting of a hydrogen, an optionally substituted alkyl, an optionally substituted cycloalkyl, an optionally substituted alkoxy, a sulfonic acid, and a hydroxy. In one or more embodiments, R₂ is selected from the group consisting of a hydrogen and an optionally substituted alkyl having 2-15 carbons, 2-12 carbons, 3-10 carbons, or 4-8 carbons. Alternatively, R₂ is a sulfonic acid. In a preferred embodiment, R₂ is a tert-butyl.

R₁ and R₃ are independently selected from the group consisting of a hydrogen, an optionally substituted alkyl, an optionally substituted cycloalkyl, an optionally substituted alkoxy, a sulfonic acid, and a hydroxy. In one or more embodiments, R₁ and R₃ are independently selected from the group consisting of a hydrogen and an optionally substituted alkyl having 2-15 carbons, 2-12 carbons, 3-10 carbons, or 4-8 carbons. In a preferred embodiment, R₁ and R₃ are a hydrogen.

As used herein, the value of n denotes the number of aromatic ring units in the macrocycle of the calixarene ligand of formula (I). In one or more embodiments, n is an integer in a range of 4-20, preferably 5-10, preferably 6-8. For example, n may be 4, 5, 6, 7, 8, 9, or 10. Preferably, n is an integer in a range of 4-8, or 5-7. Most preferably, n is 4.

In one or more embodiments, the calixarene ligand of the present disclosure is 4-tert-butylcalix[4]arene, 4-tert-butylcalix[6]arene, and/or 4-tert-butylcalix[8]arene. In a most preferred embodiment, the calixarene ligand is 4-tert-butylcalix[4]arene.

The conical configuration of calix[n]arenes may be stabilized though hydrogen-bonding interactions. In addition, the upper rim creates an electron-rich hydrophobic cavity owing to the presence of benzene rings. This structure provides calix[n]arenes the capability of hosting a wide range of guests, particularly cations, at different positions [Murphy P, Dalgarno S J, Paterson M J. Transition Metal Complexes of Calix[4]arene: Theoretical Investigations into Small Guest Binding within the Host Cavity. J Phys Chem A 2016; 120:824-39; and Lenthall J T, Steed J W. Organometallic cavitands: Cation-π interactions and anion binding via π-metallation. Coord Chem Rev 2007; 251:1747-60, each incorporated herein by reference in their entirety]. One of the potential applications of calixarenes is heavy metal extraction [Vinet L, Zhedanov A. Calixarenes 50th Anniversary: Commemorative Issue. vol. 58. 1994; Marcos P M, Ascenso J R, Segurado M A P, Pereira J L C. p-tert-butyldihomooxacalix[4]arene/p-tert-butylcalix[4]arene: Transition and heavy metal cation extraction and transport studies by ketone and ester derivatives. J Incl Phenom 2002; 42:281-8; Sliwa W. Calixarene Complexes with Transition Metal, Lanthanide and Actinide Ions. J Incl Phenom Macrocycl Chem 2005; 52:13-37; Jose P, Menon S. Lower-rim substituted calixarenes and their applications. Bioinorg Chem Appl 2007; 2007; and Dumazet-Bonnamour I, Halouani H, Oueslati F, Lamartine R. Calixarenes for metal cations extraction. Comptes Rendus Chim 2005; 8:881-91, each incorporated herein by reference in their entirety]. Modification of the lower rim though substitution that expands the cavity may facilitate the complexation with larger moieties such as heavy metals and organic molecules. The substitution of diphenylphosphoryl acetamide moieties on the lower or upper rim may result in highly efficient extraction of Pu⁺³, Eu⁺³, Th⁺³, Am⁺³, and Np⁺³ [Yordanov A T, Max Roundhill D, Mague J T. Extraction selectivities of lower rim substituted calix[4]arene hosts induced by variations in the upper rim substituents. Inorganica Chim Acta 1996; 250:295-302; Yordanov A T, Mague J T, Max Roundhill D. Solvent extraction of divalent palladium and platinum from aqueous solutions of their chloro complexes using an N,N-dimethyldithiocarbamoylethoxy substituted calix[4]arene. Inorganica Chim Acta 1995; 240:441-6; Malone J F, Marrs D J, Mckervey M A, Hagan P O, Thompson N, Arnaud-Neu F, et al. Calix[n]arene Phosphine Oxides. A New Series of Cation Receptors for Extraction of Europium, Thorium, Plutonium, and Americium in Nuclear Waste Treatment. Chem Commun 1995; 0:2151-3; and Arnaud-Neu F, Bohmer V, Dozol J F, Gruttner C, Jakobi R A, Kraft D, et al. Calixarenes with diphenylphosphoryl acetamide functions at the upper rim. A new class of highly efficient extractants for lanthanides and actinides. JChemSocPerkin Trans2 1996; 0:1175-82, each incorporated herein by reference in their entirety]. Moreover, a complex formed by introducing thiazolazo groups to all four positions of calix[4]arene may be applicable for heavy metal ion recognition [Akdogan A, Deniz M, Cebecioglu S, Sen A, Delig& H. Liquid-liquid extraction of transition metal cations by nine new azo derivatives calix[n]arene. Sep Sci Technol 2002; 37:973-80, incorporated herein by reference in its entirety]. Extensive research was conducted on calix[4]arene having various hyrdrophobic para-substituents that form a cavity with a wide upper-rim capable of storing small gas [Liu D, Cui W, Zhang S, Que G. Role of dispersed Ni catalyst sulfurization in hydrocracking of residue from Karamay. Energy and Fuels 2008; 22:4165-9; Gary D. Enright, Konstantin A. Udachin, Igor L. Moudrakovski and, Ripmeester* J A. Thermally Programmable Gas Storage and Release in Single Crystals of an Organic van der Waals Host 2003; Arduini A, Cantoni M, Graviani E, Pochini A, Secchi A, Sicuri A R, et al. Gas-phase complexation of neutral molecules by upper rim bridged calix[4]arenes. Tetrahedron 1995; 51:599-606; Atwood J L, Barbour L J, Jerga A, Schottel B L. Guest transport in a nonporous organic solid via dynamic van der Waals cooperativity. Science (80-) 2002; 298:1000-2; Hontama N, Inokuchi Y, Ebata T, Dedonder-Lardeux C, Jouvet C, Xantheas S S. Structure of the calix[4]arene-(H2O) Cluster: The world's smallest cup of water. J Phys Chem A 2010; 114:2967-72; Ozmen M, Ozbek Z, Buyukcelebi S, Bayrakci M, Ertul S, Ersoz M, et al. Fabrication of Langmuir-Blodgett thin films of calix[4]arenes and their gas sensing properties: Investigation of upper rim para substituent effect. Sensors Actuators, B Chem 2014; 190:502-11; Kaneko S, Inokuchi Y, Ebata T, Apra E, Xantheas S S. Laser spectroscopic and theoretical studies of encapsulation complexes of calix[4]arene. J Phys Chem A 2011; 115:10846-53; Horvat G, Stilinović V, Hrenar T, Kaitner B, Frkanec L, Tomis̆ić V. An integrated approach (thermodynamic, structural, and computational) to the study of complexation of alkali-metal cations by a lower-rim calix[4]arene amide derivative in acetonitrile. Inorg Chem 2012; 51:6264-78; Özbek C, Okur S, Mermer Ö, Kurt M, Sayin S, Yilmaz M. Effect of Fe doping on the CO gas sensing of functional calixarene molecules measured with quartz crystal microbalance technique. Sensors Actuators, B Chem 2015; 215:464-70; Udachin K A, Moudrakovski I L, Enright G D, Ratcliffe C I, Ripmeester J A. Loading-dependent structures of CO2 in the flexible molecular van der Waals host p-tert-butylcalix[4]arene with 1:1 and 2:1 guest-host stoichiometries. Phys Chem Chem Phys 2008; 10:4636; Thallapally P K, Wirsig T B, Barbour L J, Atwood J L. Crystal engineering of nonporous organic solids for methane sorption. Chem Commun (Camb) 2005; 0:4420-2; and Atwood J L, Barbour L J, Jerga A. A new type of material for the recovery of hydrogen from gas mixtures. Angew Chemie—Int Ed 2004; 43:2948-50, each incorporated herein by reference in their entirety] or water molecules. Thus, Hontama et al. [Hontama N, Inokuchi Y, Ebata T, Dedonder-Lardeux C, Jouvet C, Xantheas S S. Structure of the calix[4]arene-(H₂O) Cluster: The world's smallest cup of water. J Phys Chem A 2010; 114:2967-72, incorporated herein by reference in its entirety] described this cluster as “the world's smallest cup of water”.

Nevertheless, the inclusion of transition metals such as Fe and Cu at the lower-rim was found to enhance the binding of guest molecules stored in the upper-rim cavity by providing additional binding sites as well as magnetic interaction resulting from a variety of polymetallic clusters formed [Sanz S, Ferreira K, McIntosh R D, Dalgarno S J, Brechin E K. Calix[4]arene-supported FeIII2LnIII2 clusters. Chem Commun 2011; 47:9042; and Karotsis G, Kennedy S, Dalgarno S J, Brechin E K. Calixarene supported enneanuclear Cu(ii) clusters. Chem Commun 2010; 46:3884, each incorporated herein by reference in their entirety]. Murphy et al. [Murphy P, Dalgarno S J, Paterson M J. Transition Metal Complexes of Calix[4]arene: Theoretical Investigations into Small Guest Binding within the Host Cavity. J Phys Chem A 2016; 120:824-39, incorporated herein by reference in its entirety] had theoretically investigated the effects of including metal ions such as Mn³⁺ (quintet) and Fe³⁺ (quartet) on the binding energy of small guest molecules including H₂, O₂, N₂, H₂O, CO₂, N₂O, NH₃, H₂S, HCN, and SO₂ using Density Functional Theory calculations. It was found that coordination of the lower-rim of p-tert-butylcalix[4]arene with either metal had stronger binding affinity for all guest molecules than did the parent calixarene.

The catalyst comprises a complex having a metal ion coordinated to the aforementioned calixarene ligand of formula (I). Depending on the size of the cavity and available functional groups of the calixarene ligand, the metal ion may be an ion of at least one metal selected from the group consisting of a transition metal (e.g. Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs, Mt, Ds, Rg, and Cn), a post-transition metal (e.g. Al, In, Ga, Sn, Bi, Pb, Tl, Zn, Cd, and Hg), and an alkaline earth metal (e.g. Be, Mg, Ca, Sr, Ba, and Ra). Further, these metal ions may be of any oxidation state M⁺¹, M⁺², M⁺³, etc. In one or more embodiments, the metal ion is an ion of at least one transition metal selected from the group consisting of Fe, Ni, Co, Mo, Ru, Rh, Pd, W, and Re. In a preferred embodiment, the metal ion is an ion of Ni, Co, or both. In a most preferred embodiment, the metal ion is an ion of Ni.

As used herein, UV-vis spectroscopy or UV-vis spectrophotometry refers to absorption spectroscopy or reflectance spectroscopy in the ultraviolet-visible spectral region. This means it uses light in the visible and adjacent (near-UV and near-infrared) ranges. The absorption or reflectance in the visible range directly affects the perceived color of the chemicals involved. In this region of the electromagnetic spectrum, molecules undergo electronic transitions. Molecules containing π-electrons or non-bonding electrons (n-electrons) can absorb the energy in the form of ultraviolet or visible light to excite these electrons to higher anti-bonding molecular orbitals. The more easily excited the electrons (i.e. the lower the energy gap between the HOMO and the LUMO), the longer the wavelength of light it can absorb. This technique is complementary to fluorescence spectroscopy, in that fluorescence deals with transitions from the excited state to the ground state, while absorption measures transitions from the ground state to the excited state.

In one or more embodiments, the complex described herein has an ultraviolet visible absorption with an absorption band in a range of 380-600 nm, preferably 400-550 nm, preferably 420-520 nm, preferably 440-500 nm, preferably 460-480 nm. The complexation of the metal ion to the calixarene ligand causes the appearance of such distinguishable humps due to the enhancement of n-π* electronic transitions of the carbonyl group as well as the phenoxy oxygen atoms [Adhikari, B. B.; Gurung, M.; Chetry, A. B.; Kawakita, H.; Ohto, K. Highly Selective and Efficient Extraction of Two Pb2+ Ions with a P-Tert-Butylcalix[6]Arene Hexacarboxylic Acid Ligand: An Allosteric Effect in Extraction. RSC Adv. 2013:3:25950-25959; and Zahir, H. Synthesis and Characterization of Trivalent Cerium Complexes of p-tert Butylcalix[4,6,8]arenes: Effect of Organic Solvents. J. Chem. 2013:2013:494392, each incorporated herein by reference in their entirety]. In one embodiment, the complex having Co ion coordinated to the calixarene ligand of formula (I) has an absorption band at a longer wavelength relative to a complex having Ni ion coordinated to the same ligand by at least 80 nm, 90 nm, 100 nm, 105 nm, 110 nm, 115 nm, 120 nm, or at least 122 nm. In addition to the absorption band of 380-600 nm, the complex may have an absorption peak at around 275-350 nm resulted from free calixarene ligand (FIG. 9). The maximum absorption of this ligand band is attributed to the π-π* transition that arises from π electrons of carbonyl groups or electronic transition of benzene residue.

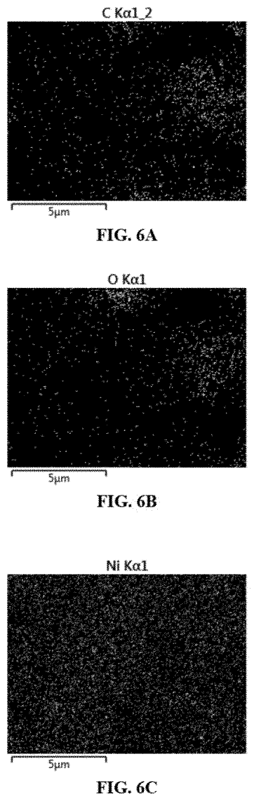

The inclusion and distribution of the metal ion within the calixarene ligand of the complex described herein may be further observed using techniques such as Energy-dispersive X-ray spectroscopy, X-ray microanalysis, elemental mapping, transmission electron microscopy, scanning electron microscopy, and scanning transmission electron microscopy. In one embodiment, nickel ions have a greater coordination with calixarene ligands than cobalt ions (see elemental mapping of FIGS. 6A-C, 7A-C).

The calixarene ligand used herein may be prepared by condensation reaction of a proper phenol (e.g. p-tert-butylphenol) and formaldehyde in the presence of a base (e.g. NaOH, KOH, Na₂CO₃, K₂CO₃) or an acid. Alternatively, the calixarene ligand used herein may be available from commercial vendors including, without limitation, Sigma Aldrich, Alfa Aesar, and TCI America.

The complex of the present disclosure may be prepared by mixing the calixarene of formula (I) (e.g. 4-tert-butylcalix[4] arene, 4-tert-butylcalix[6] arene, 4-tert-butylcalix[8]arene) with a metal salt (e.g. Ni, Co salts) having the metal ion. Prior to the mixing step, the aforementioned reagents (i.e. calixarene, metal salts) may be dissolved in a solvent separately to form respective solutions, which are then mixed to form the mixture. For example, the calixarene may be dissolved in DMF, while the metal salt (e.g. Co and Ni salts) may be dissolved in a mixture of methanol and DMSO. In a preferred embodiment, a base (e.g. triethylamine, trimethylamine, NaOH) is added to the calixarene solution prior to the addition of the metal salts. The mixing may occur via stirring, shaking, swirling, sonicating, blending, or by otherwise agitating the mixture. In one embodiment, the mixture is stirred by a magnetic stirrer or an overhead stirrer. In another embodiment, the mixture is left to stand (i.e. not stirred). In a preferred embodiment, the mixture is stirred at a temperature of 0-10° C., 2-8° C., or about 4° C. for 4-48 hours, 8-36 hours, or about 24 hours. The complex may be formed in the mixture as a precipitate that can be collected (filtered off, centrifuged), and then dried. Preferably, the complex may be collected via a Buchner funnel using a Millipore nylon membrane with a pore size of 0.4-0.8 μm, 0.5-0.7 μm, or about 0.6 μm (see Examples 3 and 7).

In a preferred embodiment, a weight ratio of the calixarene ligand to the metal salt in the aforementioned mixture is in a range of 1:5 to 1:50, 1:10 to 1:25, or about 1:20. However, in certain embodiments, the weight ratio of the calixarene ligand to the metal salt is less than 1:5 or greater than 1:50, depending on the chemical formula of the calixarene and the salt. Exemplary Ni salts include, but are not limited to, nickel(II) nitrate, nickel(II) acetate, nickel(II) acetylacetonate, nickel(II) hexafluoroacetylacetonate, nickel(II) octanoate, ammonium nickel(II) sulfate, nickel(II) chloride, nickel(II) bromide, nickel(II) fluoride, nickel(II) iodide, nickel(II) carbonate, nickel(II) hydroxide, nickel(II) perchlorate, nickel(II) sulfate, nickel(II) sulfamate, and mixtures and hydrates thereof. Preferably, Ni salt is nickel(II) nitrate hexahydrate. Exemplary Co salts include, but are not limited to, cobalt(II) nitrate, cobalt(II) nitrate hexahydrate, cobalt(II) chloride, cobalt(II) acetate, cobalt(II) sulfate, cobalt(II) bromide, cobalt(II) iodide, and mixtures and hydrates thereof. Preferably, the Co salt is cobalt(II) nitrate hexahydrate.

The use of metal-based calixarenes for catalytic purpose applies to a wide range of reactions such as olefin polymerization [Redshaw C, Rowan M A, Warford L, Homden D M, Arbaoui A, Elsegood M R J, et al. Oxo- and imidovanadium complexes incorporating methylene- and dimethyleneoxa-bridged calix[3]- and -[4]arenes: Synthesis, structures and ethylene polymerisation catalysis. Chem—A Eur J 2007; 13:1090-107; Zanotti-Gerosa A, Solari E, Giannini L, Floriani C, Re N, Chiesi-Villa A, et al. Titanium-carbon functionalities on an oxo surface defined by a calix[4]arene moiety and its redox chemistry. Inorganica Chim Acta 1998; 270:298-311; and Chen Y, Zhang Y, Shen Z, Kou R, Chen L. Ethylene polymerization catalyzed by rare earth calixarene catalytic system. Eur Polym J 2001; 37:1181-4, each incorporated herein by reference in their entirety], hydrogenation/dehydrogenation [Dieleman C, Steyer S, Jeunesse C, Matt D. Diphosphines based on an inherently chiral calix[4]arene scaffold: synthesis and use in enantioselective catalysis. J Chem Soc Dalt Trans 2001; 0:2508-17; Quintard A, Darbost U, Vocanson F, Pellet-Rostaing S, Lemaire M. Synthesis of new calix[4]arene based chiral ligands bearing β-amino alcohol groups and their application in asymmetric transfer hydrogenation. Tetrahedron: Asymmetry 2007; 18:1926-33; and Marson A, Freixa Z, Kamer P C J, van Leeuwen PWNM. Chiral Calix[4]arene-Based Diphosphites as Ligands in the Asymmetric Hydrogenation of Prochiral Olefins. Eur J Inorg Chem 2007; 2007:4587-91, each incorporated herein by reference in their entirety], oxidative dehydrogenation [Hoppe E, Limberg C. Oxovanadium(V) tetrathiacalix[4]arene complexes and their activity as oxidation catalysts. Chem—A Eur J 2007; 13:7006-16; Hoppe E, Limberg C, Ziemer B. Mono- and dinuclear oxovanadium(V) calixarene complexes and their activity as oxidation catalysts. Inorg Chem 2006; 45:8308-17; and Limberg C. Calixarene-based oxovanadium complexes as molecular models for catalytically active surface species and homogeneous catalysts. Eur J Inorg Chem 2007; 2007:3303-14, each incorporated herein by reference in their entirety], hydroformylation [Parlevliet F J, Kiener C, Fraanje J, Goubitz K, Lutz M, Spek A L, et al. Calix[4]arene based monophosphites, identification of three conformations and their use in the rhodium-catalysed hydroformylation of 1-octene. J Chem Soc Dalt Trans 2000; 0:1113-22; and Steyer S, Jeunesse C, Matt D, Welter R, Wesolek M. Heterofunctionalised phosphites built on a calix[4]arene scaffold and their use in 1-octene hydroformylation. Formation of 12-membered P,O-chelate rings. J Chem Soc Dalt Trans 2002; 0:4264-74, each incorporated herein by reference in their entirety], alkylation [Shimizu S, Suzuki T, Shirakawa S, Sasaki Y, Hirai C. Water-Soluble Calixarenes as New Inverse Phase-Transfer Catalysts. Their Scope in Aqueous Biphasic Alkylations and Mechanistic Implications. Adv Synth Catalyis 2002; 344:370-8; Sémeril D, Matt D, Toupet L. Highly regioselective hydroformylation with hemispherical chelators. Chem—A Eur J 2008; 14:7144-55; and Sémeril D, Jeunesse C, Matt D, Toupet L. Regioselectivity with hemispherical chelators: Increasing the catalytic efficiency of complexes of diphosphanes with large bite angles. Angew Chemie—Int Ed 2006; 45:5810-4, each incorporated herein by reference in their entirety], and cyclopropanation [Buhl M, Terstegen F, Loffler F, Meynhardt B, Kierse S, Muller M, et al. On the Mechanism and Stereoselectivity of the Copper(I)-Catalyzed Cyclopropanation of Olefins—A Combined Experimental and Density Functional Study. European J Org Chem 2001; 2001:2151-60, incorporated herein by reference in its entirety]. A majority of previous studies used calix[4]arenes, particularly p-tert-butyl derivative, for investigating metal-based catalysis, while the rest used calix[6]arenes, calix[8]arenes, oxacalixarenes, and some other ligand systems. The results showed that synthesizing the cluster at ethylene atmosphere gave an advanced turnover frequency at TOF=1.2 h⁻¹ and reaction orders of 0.66 in H₂ and −0.27 in ethylene. However, macrocyclic metal-based calixarene materials have not been studied for catalytic applications regarding heavy oil upgrading.

TABLE 1
Features and advantages offered by using calixarene ligands

| Features | Subsequent advantages |
|---|---|
| cheaply and easily | multigram quantities |
| synthesized | |
| ability to be | solubility control |
| functionalized | (including water) |
| ability to | enantio-discrimination |
| incorporate chirality | |
| cavity | substrate recognition |
| | multiple |
| multiple binding | cooperative effects |
| sites | |
| ability to be fixed | heterogeneous catalysis |
| on solid supports | |

Table 1 [Homden DM, Redshaw C. The use of calixarenes in metal-based catalysis. Chem Rev 2008; 108:5086-130, incorporated herein by reference in its entirety] summarizes the features and benefits of applying calixarenes as ligands in metal-based catalysis. Marson et al. [Marson A, Freixa Z, Kamer P C J, van Leeuwen PWNM. Chiral Calix[4]arene-Based Diphosphites as Ligands in the Asymmetric Hydrogenation of Prochiral Olefins. Eur J Inorg Chem 2007; 2007:4587-91, incorporated herein by reference in its entirety] studied the hydrogenation of dimethylitaconate and R-(acyl-amino)acrylate at mild conditions (i.e. 25° C. and 5 bar H₂) using rhodium-based p-tert-butyl-calix[4]arene functionalized with chiral diphosphite ligands at the lower-rim where a complete catalysis was achieved within four hours of reaction time. Palermo et al. [Palermo A, Solovyov A, Ertler D, Okrut A, Gates B C, Katz A. Dialing in single-site reactivity of a supported calixarene-protected tetrairidium cluster catalyst. Chem Sci 2017; 8:4951-60, incorporated herein by reference in its entirety] proposed another approach for using iridium-based calixarene by anchoring the metalocalixarene on a support for ethylene hydrogenation in a flow reactor at 313 K. The catalyst Ir₄L₃(CO)₉ is composed of a closed Ir₄ carbonyl cluster with a tetrahedral metal frame and three sterically bulky ligands (L: tert-butyl-calix[4]arene(OPr)₃(OCH₂PPh₂) (Ph=phenyl; Pr=propyl)) supported by porous silica. The cluster is being bonded exclusively to the basal plane through the bulky calixarene phosphine ligands. The Ir₄ cluster has a high structural stability and was fully characterized in the crystalline state, which is considered to be key advantages for application as a catalytic platform. The results show that synthesizing the cluster at ethylene atmosphere leads to an advanced turnover frequency at TOF=1.2 h⁻¹ and reaction orders of 0.66 in H₂ and −0.27 in ethylene.

The solubility of calix[n]arenes may be enhanced by derivatization of the parent molecule, which was demonstrated by hexaacetate p-methylcalix[6]arene [Fujita J, Ohnishi Y, Ochiai Y, Matsui S. Ultrahigh resolution of calixarene negative resist in electron beam lithography. Appl Phys Lett 1995; 68:1297; and Novembre A, Liu S. Chemistry and processing of resists for nanolithography. Woodhead Publishing Limited; 2013, each incorporated herein by reference in their entirety]. The thermal stability of a calixarene is advantageous for various applications that require a high temperature environment, such as ink-jet printing, dyeing of textile fibers, photocopying, as well as in other technologies such as lasers and electro-optical devices [Deligoz H, Karakuş Ö Ö, Çilgi G K. A brief review on the thermal behaviors of calixarene-azocalixarene derivatives and their complexes. J Macromol Sci Part A Pure Appl Chem 2012; 49:259-74, incorporated herein by reference in its entirety]. Calix[n]arenes are considered to have relatively high thermal (Tm>300° C.) and chemical stabilities [Novembre A, Liu S. Chemistry and processing of resists for nanolithography. Woodhead Publishing Limited; 2013, incorporated herein by reference in its entirety]. A study conducted by Delig& et al. [Deligöz H, Karakuş Ö Ö, Çilgi G K. A brief review on the thermal behaviors of calixarene-azocalixarene derivatives and their complexes. J Macromol Sci Part A Pure Appl Chem 2012; 49:259-74, incorporated herein by reference in its entirety] on calix[n]arene-Fe³⁺ complexes (n=4, 6, 8) by performing thermogravimetric analysis under nitrogen gas flowing at atmospheric pressure found that coordination of metal with calixarenes would affect its thermal stability. It was observed that these complexes started to degrade beyond 200° C. Because of decomposition of the complexes was also reported in other studies, it can be concluded that thermal stability of these complexes started to vanish at this temperature [Kůtek F. Beitrage zur Chemie der selteneren Elemente XXXIX. Additionsverbindungen des N,N-Dimethylformamids and N,N-Dimethylacetamids mit Scandiumperchlorat. Collect Czechoslov Chem Commun 1967; 32:3767-70; Krishnamurthy S S, Soundararajan S. Dimethyl and Diphenyl Formamide Complexes of Lanthanide Perchlorates. Can J Chem 1969; 47:995; and Bunzli J C G, Froidevaux P, Harrowfield J M. Complexes of lanthanoid salts with macrocyclic ligands. 41. Photophysical properties of lanthanide dinuclear complexes with p-tert-butylcalix[8]arene. Inorg Chem 1993; 32:3306-11, each incorporated herein by reference in their entirety]. However, for processes operated at relatively severe conditions (e.g. ˜400° C.) such as heavy oil upgrading, the limited degree of thermal stability is being exploited by employing the organometallic complex as a carrier for metal where the active sites are being formed during the destruction of the complex upon reaching desired reaction conditions, which was applied for other ligands derived from organic compounds such as 2-ethylhexanoic acid and naphthenic acid.

The present disclosure relates to a method for hydrocracking a hydrocarbon feedstock containing long-chain hydrocarbons using a catalyst comprising the aforementioned complex. As used herein, cracking is a process whereby complex organic molecules such as long-chain hydrocarbons are broken down into simpler molecules such as light hydrocarbons, via the breaking of carbon-carbon bonds in the precursors. Hydrocracking is a catalytic cracking process assisted by hydrogen gas used in petroleum refineries. Hydrocracking converts high-boiling, long-chain hydrocarbons in crude oils to more valuable lower-boiling petroleum products such as gasoline, kerosene, jet fuel, and diesel oil.

The hydrocarbon feedstock that may be subjected to hydrocracking by the method of the present disclosure includes all mineral oils and synthetic oils (e.g., shale oil, tar sand products, etc.) and fractions thereof. Non-limiting exemplary hydrocarbon feedstocks include those containing components boiling above about 260° C., such as Fischer-Tropsch liquids, atmospheric gas oils, vacuum gas oils, deasphalted petroleum products, vacuum, and atmospheric residual oils, hydrotreated or mildly hydrocracked residual oils, coker distillates, straight run distillates, solvent-deasphalted oils, pyrolysis-derived oils, high boiling synthetic oils, cycle oils and cat cracker distillates. In one or more embodiments, the hydrocarbon feedstock applicable to the current method contains C₂₀ through C₅₀, C₂₂ through C₄₅, C₂₄ through C₄₀, C₂₆ through C₃₅, or C₂₈ through C₃₀ hydrocarbons that boil in a range of 300-700° C., 350-650° C., 400-600° C., or 450-550° C. In a preferred embodiment, the hydrocarbon feedstock comprises vacuum gas oil (VGO).

Vacuum gas oil or VGO is part of the petroleum hydrocarbon heavy distillate family. Heavy vacuum gas oils (petroleum) are known in the art, for example, those identified by CAS number 64741-57-7 or EC number 265-058-3 which describe a material that is a complex combination of hydrocarbons produced by the vacuum distillation of the residuum from atmospheric distillation of crude oil. It contains mostly hydrocarbons having carbon numbers predominantly in the range of C₂₀ through C₅₀ and boiling in the range of approximately 350-600° C., 400-550° C., or 450-500° C. The VGO stream used herein may contain 10 wt % or more of aromatic hydrocarbons, preferably 20-80 wt %, preferably 40-75 wt %, preferably 60-70 wt %, or about 68 wt % of aromatic hydrocarbons. Non-limiting examples of aromatic hydrocarbons that may be hydrocracked using the method of the current disclosure include anthracene, benzopyrene, chrysene, coronene, corannulene, naphthacene, naphthalene, pentacene, phenanthrene, pyrene, triphenylene, and ovalene.

Vacuum gas oil is also known as “cat feed”, which is a feedstock for fluid catalytic crackers used to make gasoline, gasoil, and many other by-products. There are various names for and types of VGO including Heavy Vacuum Gas Oil (HVGO), Heavy Gas Oil, Heavy Vacuum Distillate, Partially Refined Heavy Gas Oil, Vacuum Tower Heavy Gas Oil, Vacuum Tower Side stream, Feedstock to the 634 Hydrodesulfization Unit, Untreated FCCU Feedstock, Cracker Unit Feedstock, No. 6 Fuel Oil Blending Component, Heavy Fuel Oil Blending Component, Unfinished Bunker Fuel, and C₂₀-C₅₀ Petroleum Hydrocarbons. In some embodiments, VGO is collected from the Saudi Aramco Refinery, Saudi Arabia.

Hydrogenation reactions catalyzed by metal-based calixarene were studied by Marson et al. [Marson A, Freixa Z, Kamer P C J, Van Leeuwen PWNM. Chiral calix[4]arene-based diphosphites as ligands in the asymmetric hydrogenation of prochiral olefins. Eur J Inorg Chem 2007; 2007:4587-91, incorporated herein by reference in its entirety] on mild hydrogenation (25° C., 5 bar H₂) of dimethylitaconate and α-(acyl-amino)acrylate. However, since hydrocracking of heavy oil is often conducted under severe conditions such as high temperature (e.g. 390-450° C.) and high pressure (e.g. 8.5 MPa), another scenario of catalytic performance of metal-based calixarenes was suggested based on their thermal stability. The metal-based calixarene is found to be effectively soluble in vacuum gas oil. Due to limited thermal stability, the metals of oil-soluble organometallic compounds (e.g. metal-based calixarene) may leach from the complex when the thermal and pressure conditions of the hydrocracking process are extreme [Bdwi E A S, Ali S A, Quddus M R, Al-Bogami S A, Razzak S A, Hossain M M. Kinetics of Promotional Effects of Oil-Soluble Dispersed Metal (Mo, Co, and Fe) Catalysts on Slurry Phase Hydrocracking of Vacuum Gas Oil. Energy & Fuels 2017; 31:3132-42; and Liu C, Zhou J, Que G, Liang W, Zhu Y. Hydrocracking of Gudao residue with dispersed-phase Mo catalyst. Fuel 1994; 73:1544-50, each incorporated herein by reference in their entirety]. The leached metals may then react with the sulfur content (e.g. hydrogen sulfide) that is inherently present or later formed in the feedstock. This may lead to formation of highly dispersed metal sulfide crystals which are inherently active sites for catalyzing hydrogenation reactions. Thus, the calixarene ligand used herein may function as a carrier for transition metals and promote the dispersion of metal sulfide into the feedstock (e.g. VGO), which ultimately enhances the hydrogenation reactions by reducing coke formation and maximizing the yields of lower boiling-point products. FIG. 11 describes an in-situ sulfidation of metals leached from metal-based TBC[4] and oil-soluble 2-ethylhexanoate organometallic compounds.

In one or more embodiments, the hydrocarbon feedstock applicable to the presently disclosed method has a sulfur content of 0.5-5 wt % relative to a total weight of the hydrocarbon feedstock, preferably a sulfur content of 1-4.5 wt %, preferably 1.5-4 wt %, preferably 2-3.5 wt %, preferably 2.5-3 wt %, or about 2.67 wt % relative to the total weight of the hydrocarbon feedstock. Sulfur-containing compounds in the hydrocarbon feedstock may be hydrogenated and converted into gaseous hydrogen sulfide.

As used herein, “parts per million” or “ppm” refers to an expression of concentration by mass or weight. For example, 1 ppm of a complex denotes a 1:1,000,000 weight ratio of the complex per total weight of feedstock fluid (e.g. liquids, gases or combinations thereof). Alternatively, 1 ppm of a complex denotes a 1:1,000,000 weight ratio of the complex per total weight of feedstock fluid contained or carried within an oil and gas hydrocracking reactor.

The method involves the step of mixing the hydrocarbon feedstock and the catalyst to form a slurry. In one or more embodiments, the aforementioned complex having the metal ion coordinated to the calixarene ligand of formula (I) is present in the slurry at a concentration of 500-20,000 ppm, preferably 750-15,000 ppm, preferably 1,000-10,000 ppm, preferably 2,000-9,000 ppm, preferably 3,000-8,000 ppm, preferably 4,000-7,000 ppm, preferably 5,000-6,000 ppm. However, in certain embodiments, the complex is present in the slurry at a concentration that is less than 500 ppm or greater than 20,000 ppm. Alternatively, the metal ion (e.g. Co, Ni ions) may be present in the slurry in a coordinated form to the calixarene ligand at a concentration of 50-1,000 ppm, preferably 75-900 ppm, preferably 100-800 ppm, preferably 200-700 ppm, preferably 300-600 ppm, preferably 400-500 ppm.

Different types of hydrocracking equipment including single-stage once through hydrocracker, single-stage recycle hydrocracker, and two-stage hydrocracker may be used for the method disclosed herein. The slurry comprising the hydrocarbon feedstock and the catalyst may be in a liquid state or a gaseous state. In view of that, mixing the hydrocarbon feedstock and the catalyst may be different, depending on the state of the hydrocarbon feedstock, i.e. the liquid state or the gaseous state. In preferred embodiments, the hydrocarbon feedstock is in a liquid phase and the hydrocarbon feedstock is mixed with the catalyst in a batch reactor equipped with a rotary agitator to form a heterogeneous slurry mixture. Preferably, the batch reactor is an autoclave batch reactor. In one embodiment, the slurry in the autoclave batch reactor is agitated at a speed of 200-1,500 rpm, preferably 400-1,250 rpm, preferably 600-1,000 rpm, or about 950 rpm during hydrocracking. It should be noted that FIG. 2 is a simplified setup diagram and many pieces of process equipment, such as fractionators, separators, and compressors have been omitted for clarity.

Alternatively, the hydrocarbon feedstock is in a liquid state or in a gaseous state and the hydrocarbon feedstock is passed through the catalyst via a fixed-bed or a fluidized-bed reactor. In another embodiment, the hydrocarbon feedstock is in a gaseous state and the hydrocarbon feedstock is passed over the catalyst, or may stay stagnant over the catalyst, i.e. as an atmosphere to the catalyst.

The present method also involves the step of heating the slurry in the presence of H₂ gas, thereby forming a hydrocracked product. The hydrocarbon feedstock may be contacted with the catalyst in the presence of H₂ gas under favorable reaction conditions to convert at least a portion of the feedstock into at least one hydrocracked product. In a preferred embodiment, the slurry comprising the hydrocarbon feedstock and the catalyst is heated at a temperature in a range of 300-550° C., preferably 350-500° C., more preferably 400-450° C., even more preferably at around 420° C. In a related embodiment, the slurry is heated for 0.1-5 hours, 0.25-4 hours, 0.5-3 hours, 0.75-2 hours, or about 1 hour. In one or more embodiments, a pressure of the H₂ gas is in a range of 3 to 10 MPa, preferably 4 to 9.5 MPa, preferably 5-9 MPa, preferably 6-8.5 MPa, preferably 7-8 MPa.

In one or more embodiments, the hydrocracked product of the present method comprises a middle distillate, a naphtha, or both. As used herein, naphtha is a flammable liquid hydrocarbon mixture. Light naphtha is the fraction boiling between about 30° C. and about 90° C. and often contains hydrocarbon molecules with 5-6 carbon atoms. Heavy naphtha boils between about 90° C. and about 221° C. and may contain hydrocarbon molecules with 6-12 carbon atoms. As used herein, a “middle distillate” is defined as having fractions that boil in the range of about 221° C.-343° C. For example, at least 75 vol %, preferably 85 vol % of the components of a middle distillate may have a normal boiling point of greater than 221° C. At least about 75 vol %, preferably 85 vol % of the components of a middle distillate may have a normal boiling point of less than 343° C. Exemplary middle distillates include diesel, jet fuel, and kerosene boiling range fractions. The kerosene or jet fuel boiling point range refers to the range between about 138° C. and about 274° C. The term “diesel boiling range” refers to hydrocarbons boiling in the range from 121° C. to 343° C.

Preferably, the naphtha obtained by the currently disclosed method is a heavy naphtha boiling in a range of 90-221° C., more preferably 100-210° C., 120-200° C., or 130-180° C. In a related embodiment, when the naphtha is present in the hydrocracked product of the present method, a yield of the naphtha ranges from 7-30 wt % relative to a weight of the hydrocarbon feedstock, preferably the yield of the naphtha ranges from 10-28 wt %, 15-25 wt %, or 18-22 wt % relative to a weight of the hydrocarbon feedstock. In another related embodiment, when the middle distillate is present in the hydrocracked product, a yield of the middle distillate ranges from 30-55 wt % relative to a weight of the hydrocarbon feedstock, preferably the yield of the middle distillate ranges from 35-52 wt %, 40-50 wt %, or 45-48 wt % relative to a weight of the hydrocarbon feedstock.

As used herein, coke (petroleum coke, petcoke), is a final carbon-rich solid material that derives from oil refining. Coke formation is usually unwanted as it indicates a loss of desired product and a reduction in refinery unit performance. In one or more embodiments, the method disclosed herein in any of its embodiments produces coke in an amount of less than 5 wt % relative to a weight of the hydrocarbon feedstock, preferably produces coke in an amount of less than 4 wt %, less than 3 wt %, or less than 2 wt % relative to a weight of the hydrocarbon feedstock.

In one embodiment, the method disclosed herein in any of its embodiments has an overall hydrocarbon feedstock conversion ranging from 68% to 95%, preferably from 70% to 90%, preferably from 75% to 88%, preferably from 80% to 85%. The overall hydrocarbon feedstock conversion is calculated as ((mass of original feedstock−mass of unreacted feedstock)/mass of original feedstock)×100%.

In one or more embodiments, the catalyst further includes a supported hydrocracking catalyst to synergistically boost catalytic performance of the currently disclosed method. Preferably, the supported hydrocracking catalyst comprises tungsten, nickel, or both. The supported hydrocracking catalyst used herein may also have a catalyst support. The catalyst support may involve amorphous Al₂O₃, amorphous SiO₂, Y-zeolite, or mixtures thereof. Preferably, the catalyst support has a mixed phase of amorphous Al₂O₃—SiO₂ and Y-zeolite. In a most preferred embodiment, the supported hydrocracking catalyst used herein together with the previously described complex is KC-2710 (see Table 3 for physical and chemical properties of KC-2710). In one or more embodiments, a weight ratio of the supported hydrocracking catalyst to the hydrocarbon feedstock ranges from 1:5 to 1:50, preferably ranges from 1:10 to 1:40, preferably ranges from 1:15 to 1:30, or about 1:20.

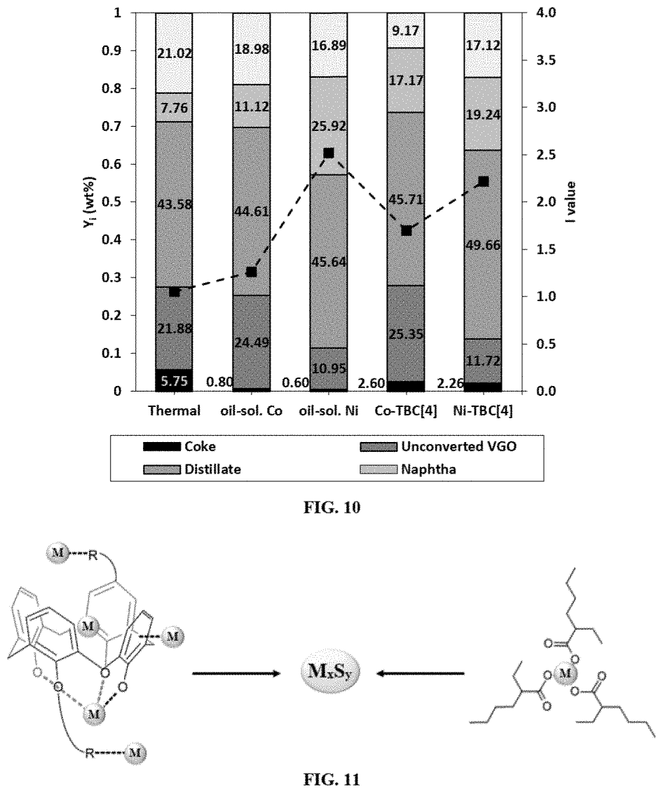

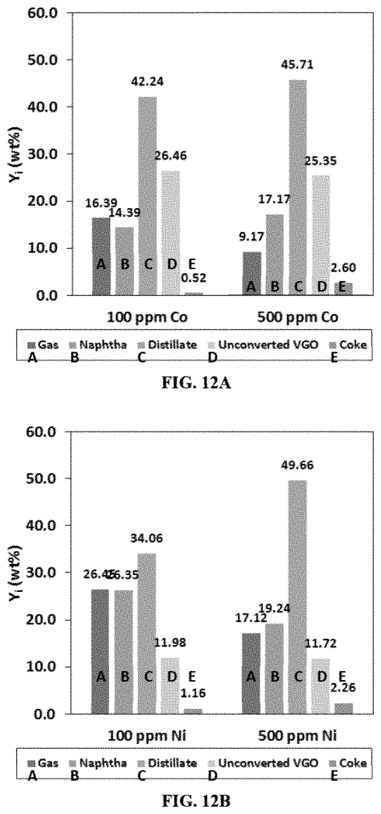

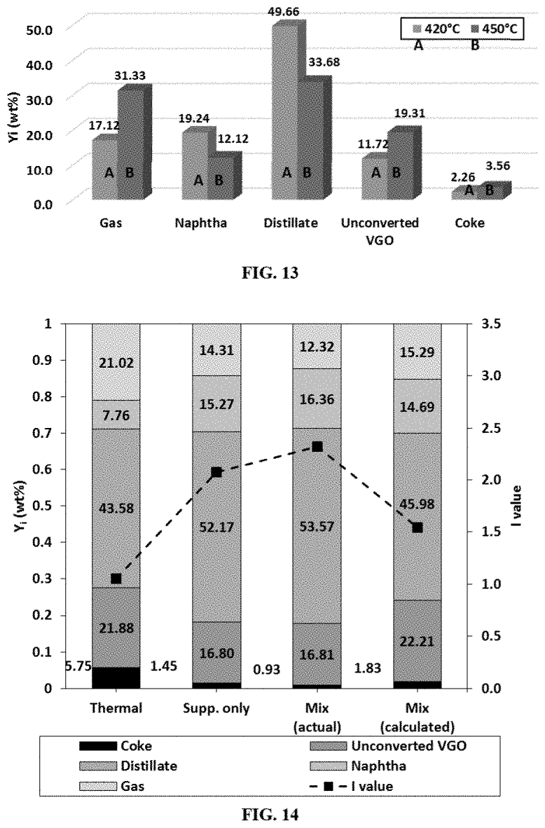

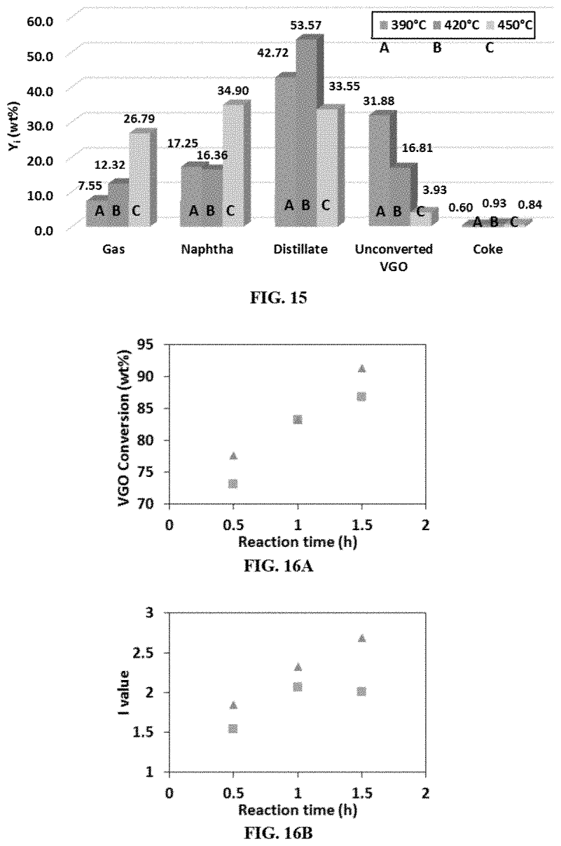

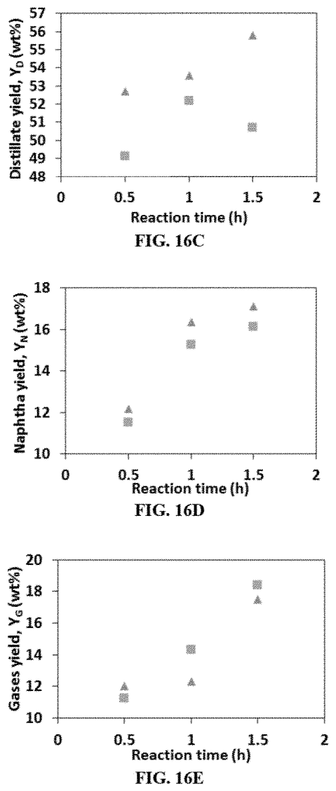

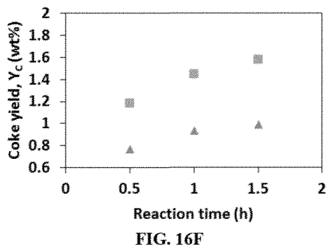

As shown in the following Examples (e.g., Examples 9 and 10), catalysts such as the metal-calixarene complex, oil-soluble catalysts, and supported catalyst were used for hydrocracking VGO as feedstocks (see FIG. 10). Work was conducted with different catalyst systems in order to explore potential synergy of mixed catalysts having the complex and the supported catalyst. The effects of metal ions, complex concentration (see FIGS. 12A-B), and heating temperature (see FIG. 13) were evaluated. In addition, synergistic effects were confirmed by comparing the product yields distribution for hydrocracking using solely the complex with a mixed catalyst of the complex and the supported catalyst (see FIGS. 15 and 16A-F).

The examples below are intended to further illustrate protocols for preparing, characterizing metal-calixarene complexes, and uses thereof in hydrocracking processes, and are not intended to limit the scope of the claims.

### EXAMPLE 1

### Materials

All chemicals used were of analytical grade and used as received without further purification. For synthesizing the metal-based calixarene, 4-tert-butylcalix[4]arene (C₄₄H₅₆O₄, ≥99.0%), cobalt(II) nitrate hexahydrate (Co(NO₃)₂.6H₂O, reagent grade, ≥98.0%), nickel(II) nitrate hexahydrate (Ni(NO₃)₂.6H₂O, 99.999% trace metals basis), N,N-dimethylformamide (HCON(CH₃)₂, anhydrous, 99.8%), dimethyl sulfoxide ((CH₃)₂SO, reagent grade, 99.5%), triethylamine ((C2H₅)₃N, ≥99.5%), and methanol (CH₃OH anhydrous, 99.8%) were obtained from Sigma-Aldrich, USA. Nickel(II) 2-ethylhexanoate (78% in 2-Ethylhexanoic acid, 10-15% Ni) and cobalt(II) 2-ethylhexanoate (65 wt % in mineral spirits 12 wt % Co) were also received from Sigma-Aldrich, USA. They were implemented as oil-soluble dispersed organometallic catalyst precursors for the sake of comparing their catalytic behaviors with the synthesized metal-based calixarenes.

The feedstock for the hydrocracking process is vacuum gas oil (VGO). Gas oil is considered as a mixture of organic chemicals produced via distillation of petroleum and it has a boiling point ranging between kerosene and lubricating oil. The vacuum gas oil is a more viscous form of gas oil and is produced through vacuum distillation of the atmospheric residue which is the bottom effluent of the atmospheric distillation unit in the refinery. In this disclosure, VGO sample was collected from Saudi Aramco Refinery, Saudi Arabia. Table 2 shows the physical and chemical properties of the vacuum gas oil. Hydrogen and nitrogen gases used in the evaluation step were purchased from the SIGAS Company with a purity of 99.999%.

TABLE 2
Physical and chemical properties of the vacuum gas oil (VGO)

| Properties | Value |
|---|---|
| Appearance | soft but solid at |
| | room temperature |
| Color | greenish dark |
| | brown |
| Density (g/cm³ at | 0.892 |
| 15° C.) | |
| Molecular weight | 442.7 |
| Initial boiling | 343 |
| point, IBP (° C.) | |
| Final boiling | 641 |
| point, FBP (° C.) | |

Elemental analysis (wt %)

| | |
|---|---|
| Carbon | 85.1 |
| Hydrogen | 11.95 |
| Sulfur | 2.667 |
| Nitrogen | 0.215 |

HPLC analysis (wt %)

| | |
|---|---|
| Saturates | 13.3 |
| Aromatics | 68.1 |
| Polars | 18.6 |

A supported catalyst of commercial type for first-stage hydrocracking named KC- 2710 was used to study the synergic effects of applying it along with the synthesized dispersed catalyst in this study. The commercial catalyst is composed of tungsten and nickel metal sites supported by a mixed phase of amorphous Al₂O₃—SiO₂ (55 wt %) and Y-Zeolite (45 wt %). The textural and structural properties of the supported commercial catalyst are listed in Table 3.

TABLE 3
Properties of Commercial Hydrocracking Catalyst (KC-2710)

| Property | Unit | Value |
|---|---|---|
| BET Surface Area | m²/g | 346 |
| Pore Volume | mL/g | 0.37 |
| Average Pore Diameter | nm | 4.3 |
| Total Acidity | μmol/g | 844 |

Chemical Composition:

| | | |
|---|---|---|
| SiO₂ | wt % | 33 |
| Al₂O₃ | wt % | 38 |
| WO₃ | wt % | 23 |
| NiO | wt % | 6 |
| Support phase | | Amorphous |
| | | SiO₂—Al₂O₃ and |
| | | Y-Zeolite (45 wt %) |

The catalyst was crushed and sieved to particles having a size between 0.5 mm and 1.0 mm to meet the suitable size for application in a slurry phase auto-clave batch reactor. To investigate the transformation of metal sites into their active sulfided form, the catalyst was sulfided ex-situ in a fixed-bed reactor. A standard presulfiding procedure was followed using a straight-run gas oil spiked with dimethyl disulfide (DMDS). The volume of catalyst loaded in the reactor was 25 mL. The sulfur content of the spiked feed was adjusted to 2.5 wt % by addition of DMDS. Hydrogen was first introduced at 10.0 L/h to pressurize the reactor system to 40 bars at room temperature. Then the flow of white kerosene was started at about 50 ml/h (˜42 g/h) under hydrogen pressure. The reactor temperature was increased from room temperature to 175° C. at a rate of about 25° C./h. The spiked feed was introduced at this point while the temperature increased to 200° C. The temperature was held at 200° C. for one hour before it was further increased to 350° C. at a rate of about 25° C./h. These conditions were maintained overnight (16 hours) to ensure a complete presulfiding.

### EXAMPLE 2

### Synthesis of Metal-Based p-tert-butylcalix[4]arene

The dispersed catalysts were nickel-p-tert-butylcalix[4]arene and cobalt-p-tert-butylcalix[4]arene. Theses complexes were synthesized based on the parent host which is p-tert-butylcalix[4]arene, hereafter referred to as TBC[4]. The metal precursors for the Ni and Co were nickel(II) nitrate hexahydrate, and cobalt(II) nitrate hexahydrate, respectively. The host calixarene structure was prepared by adding 100 mg of TBC[4] to 10 mL dimethylformamide (DMF) and then heating to 60° C. on stirrer. The mixture was kept on stirrer until it turned to be a colloidal solution. After that, 0.6 mL of triethylamine was added to the mixture drop wise until the mixture turned clear. For preparing the metal precursors of nickel and cobalt, cobalt(II) nitrate hexahydrate and nickel(II) nitrate hexahydrate were used. A mixture of 10 mL of methanol and 1.5 mL of dimethyl sulfoxide (DMSO) was added drop wise to 2 g of each precursor. The metal precursor mixture was put on stirrer until it got mixed well. Upon completion of the previous steps, the two prepared mixtures, the host source and metal source, were mixed on stirrer for 24 hours in an ice bath at 4° C. It was noticed that for each mixture prepared, the formation of colloidal occurred after 30 minutes of stirring in the ice bath, which indicated that the complex was formed.

Finally, the prepared metal-based calixarenes were filtered using vacuum filtration method. A Buchner flask with hose was connected to a vacuum to suck the fluid through the filter with the aid of gravity. This greatly speeded up the separation and could be used to dry the solid. Millipore nylon membrane (Isopore membrane filters) was used with a pore size of 0.6 μm. The use of such type of filter membranes ensured that an optimum separation of solid particles was attained. Also, the use of Millipore nylon membrane, unlike the conventional filter paper, ensured ease of retrieving the yield powder without introducing filter membrane's texture. The filtration was done by pouring the mixture and then starting the suction, which created a vacuum inside the flask. Upon completion, the residue which was the product of interest in this instance was transferred to a Petri dish, covered and put outside at room temperature to evaporate the remaining moisture.

### EXAMPLE 3

### Evaluation in the Autoclave Batch Reactor

The use of an autoclave batch reactor is favorable for scientific researches because it could provide information about the conversion and selectively of the reaction as well as the catalyst's activity and stability. The autoclave batch reactor is also widely used to get different experimental results at various residence times and temperatures that could be modeled to get kinetic parameters such as activation energy and intrinsic rate constant. The reactor used in this study was received from Parker Autoclave Engineers, USA.

The reactor size was 300 mL and was fitted manually with an agitator that was controlled by a motor. The reactor was housed in a heating jacket that provided the required heat by electrical mean. The reactor was fitted with a pressure gauge and two thermocouples to read the temperature of the heating jacket as well as the reactants' mixture inside the reactor. The reactor was also fitted with a gas supply from two cylinders which were nitrogen and hydrogen. The nitrogen gas was used for purging and to perform the leak test prior the reaction to ensure no leakage was taking place. The hydrogen gas, on the other hand, was used as a reactant in the hydroprocessing reactions and to provide a sufficient high pressure required for the process. The system was connected to a console that controlled the speed of agitation and heating supply and read the actual pressure and temperature of the reactor. FIG. 1 shows the experiential setup of the autoclave batch reactor used herein.

For each experiment, a desired amount of the vacuum gas oil was weighed, mixed with a chosen amount of the catalyst, and then fed to the batch reactor. Leak test was performed by purging nitrogen gas three times to ensure that the system was ready to be started. Then, the heater was started to achieve the desired reaction temperature (i.e. 390, 420, and 450° C.) and an initial amount of hydrogen gas was fed at 3 MPa to minimize the probability of the reaction taking place during the heating period. When the temperature reached the setpoint, hydrogen gas was fed at 8.5 MPa which was the chosen pressure for the hydrocracking reaction. Also, the agitator was running at 950 rpm to enhance the mixing of the feed with the catalyst and the hydrogen and to minimize the external mass transfer limitation in case of solid supported catalyst. The reactor was kept at these conditions for a required reaction time (i.e. 0.5, 1, and 1.5 hour).

When the process completed, the reactor was allowed to cool down to 100° C. to suppress the hydrocracking reaction. Then gas sample was taken using a gas sampling bag and the excess gas was vented into the fume hood. The reactor was purged with nitrogen to ensure that no reactive gas was left. The amount of gas produced was found by measuring the weight of the mixture of liquid product and coke produced and determining the difference with a fresh feed. After that, the coke amount produced was found by conducting the coke analysis while the liquid product was analyzed by the TGA.

A vacuum filtration unit was employed for analyzing the amount of coke formed during the hydrocracking process. A Buchner flask with hose was used to apply a vacuum to the fluid through the filter with the aid of gravity. This greatly speeded the separation and could be used to dry the solid. Millipore nylon membrane was used as a surface filter membrane with a pore size of 0.6 The use of such type of filter membranes ensured that an optimum separation of solid particles was attained. Also, the use of Millipore nylon membrane, unlike the conventional tilter paper, ensured the ease of retrieving the yield powder without introducing the filter membrane's texture. The filtration was done by pouring the mixture and then starting the suction, which created a vacuum inside the flask.

Upon completion, the residue, which was the analyte of interest in this case, was washed with toluene and centrifuged at 3000 rpm for 20 minutes to ensure that any remaining materials, such as metal dispersed catalysts, were separated from the coke. Then, the coke was transferred to a Petri dish and put in an oven for two hours to evaporate the remaining liquids. Finally, the amount of coke formed during the hydrocracking process was determined by weighing the dried coke.

A thermogravimetric analyzer (TGA) of model SDT Q600 received from TA instrument was used in this work to study the product distribution of the hydrocracking to learn about the amount of each chemical lump based on boiling point ranges, which was used by previous studies [Ortiz-Moreno H, Ramirez J, Cuevas R, Marroquin G, Ancheyta J. Heavy oil upgrading at moderate pressure using dispersed catalysts: Effects of temperature, pressure and catalytic precursor. Fuel 2012; 100:186-92; Ortiz-Moreno H, Ramirez J, Sanchez-Minero F, Cuevas R, Ancheyta J. Hydrocracking of Maya crude oil in a slurry-phase batch reactor. II. Effect of catalyst load. Fuel 2014; 130:263-72; Puron H, Arcelus-Arrillaga P, Chin K K, Pinilla J L, Fidalgo B, Millan M. Kinetic analysis of vacuum residue hydrocracking in early reaction stages. Fuel 2014; 117:408-14; Puron H, Pinilla J L, Berrueco C, Montoya De La Fuente J A, Millán M. Hydrocracking of maya vacuum residue with NiMo catalysts supported on mesoporous alumina and silica-alumina. Energy and Fuels 2013; 27:3952-60; Martinez-Grimaldo H, Ortiz-Moreno H, Sanchez-Minero F, Ramirez J, Cuevas-Garcia R, Ancheyta-Juarez J. Hydrocracking of Maya crude oil in a slurry-phase reactor. I. Effect of reaction temperature. Catal Today 2014; 220-222:295-300; and Bdwi E A S, Ali S A, Quddus M R, Al-Bogami S A, Razzak S A, Hossain M M. Kinetics of Promotional Effects of Oil-Soluble Dispersed Metal (Mo, Co, and Fe) Catalysts on Slurry Phase Hydrocracking of Vacuum Gas Oil. Energy & Fuels 2017; 31:3132-42, each incorporated herein by reference in their entirety]. Table 4 shows a summary of the experimental conditions applied for conducting the TGA.

TABLE 4
Summary of Experimental Conditions used for TGA

| | Experimental |
|---|---|
| Variable | condition |
| Temperature range | 25° C. to 600° C. |
| Sample/reference Cups | Alumina |
| Heating rate | 10° C. |

### EXAMPLE 4

### Characterization of Metal-Based p-tert-butylcalix[4]arene: SEM-EDX Analysis

To understand the morphology of the synthesized metal-based TBC[4] complexes, SEM was conducted using JEOL JSM-6460LV Scanning Electron Microscope operated at an accelerating voltage of 20 kV that also produced energy dispersive X-ray (EDX) used to identify the elemental composition of the samples. Prior to conducting the analysis, each sample was coated with gold (5 nm thickness) on a sputter coating machine. Then, the coated samples were placed at a holder for the bombardment of electrons on the samples. SEM images were taken for parent calixarene, TBC[4], as well as its metal-based derivatives with nickel and cobalt.

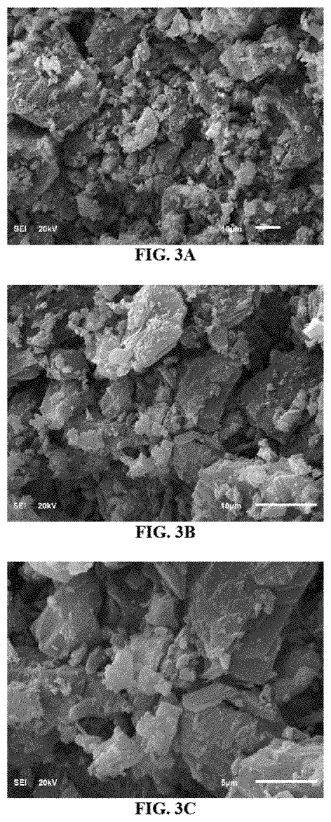

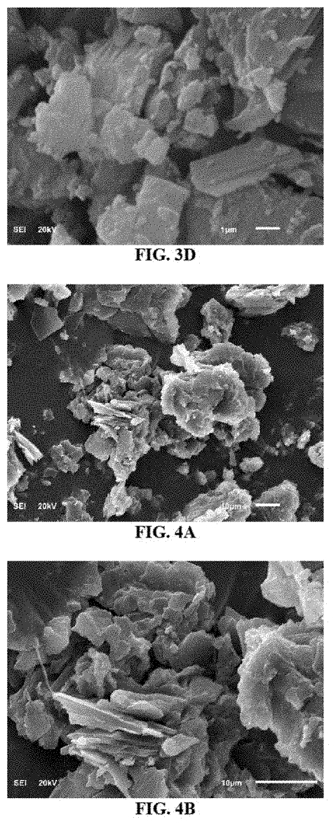

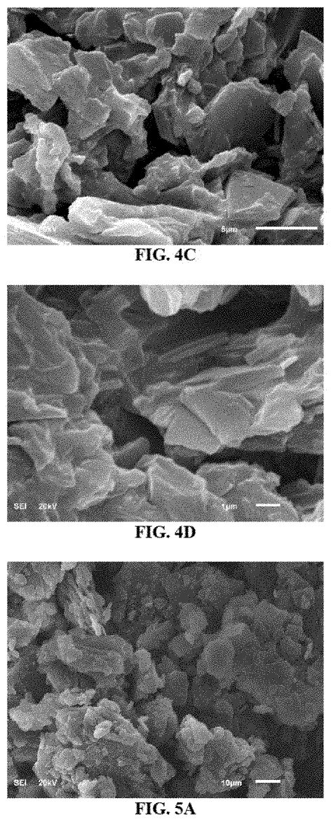

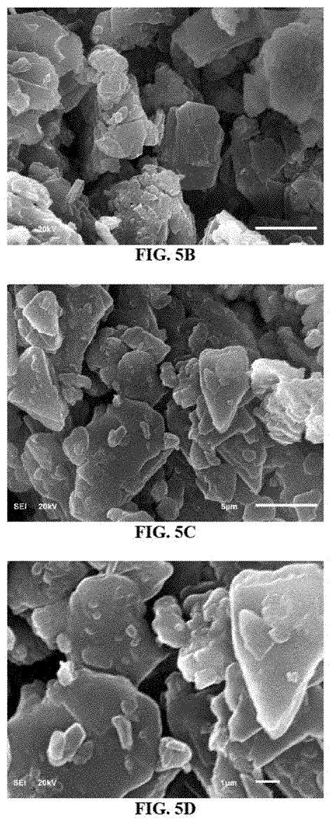

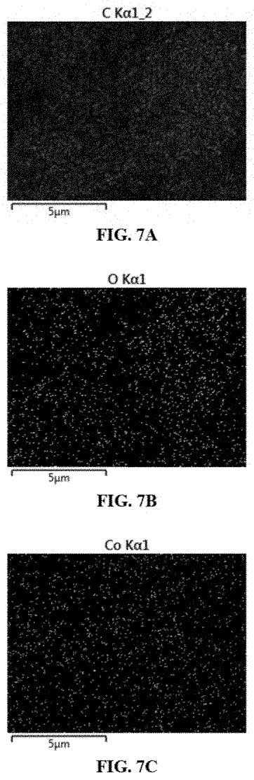

Different magnifications at ×1000, ×2500, ×5000, and ×10000 were applied to have a fuller insight into the surface geometry. The free calixarene (FIGS. 3A-D) showed a scattered surface structure. However, the formed complex of Ni-TBC[4] and Co-TBC[4] (FIGS. 4A-D and FIGS. 5A-D) demonstrated a smooth homogeneous surface with crystal structure geometry. Energy dispersive X-ray (EDX) analysis was applied at a magnification of ^{x} 10000 for all samples and the results confirmed that nickel was being included by the calixarene better than cobalt. Mapping was also conducted for applied at magnification of ^{x} 10000 for all metal-based calixarenes prepared. FIGS. 6A-C show that nickel exhibited a high level of homogeneity relative to carbon and hydrogen. This observation was also found in the cobalt complex as depicted in FIGS. 7A-C, which confirmed that the cations are interacting with the p-tert-butylcalix[4]arene with a high level of homogeneity.

### EXAMPLE 5

### Characterization of Metal-Based p-tert-butylcalix[4]arene: X-Ray Diffraction Characterization (XRD)

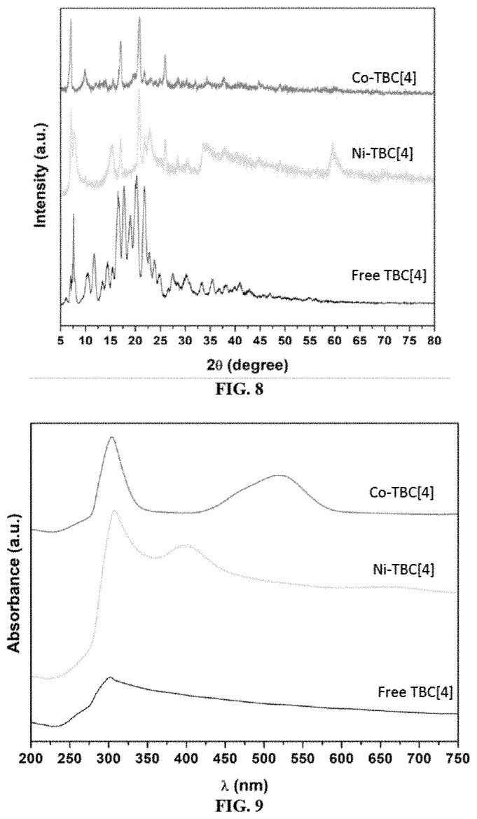

XRD analysis was carried out to identify crystals structure of the prepared catalysts. XRD analysis was performed using a Rigaku X-ray diffractometer with Cu-Kα radiation and 2θ in a range between 5° and 80° at a scanning rate of 0.02° min⁻¹. FIG. 8 shows the X-ray diffraction patterns of the host ligand, p-tert-butylcalix[4]arene, as well as its derivatives with nickel and cobalt. The XRD patterns show that the calixarene as well as its derivatives had a generally crystalline structure. However, the reduction of distinguishable peaks after forming the metalocalixarene indicates that the formed complexes have higher crystalline structures, which confirms the occurrence of complexation.

Since complex formation doesn't affect the general pattern of XRD significantly, it is considered to be a suitable approach to identify the complexes formed based on changes occurred relative to the free calixarene XRD pattern [Benevelli F, Kolodziejski W, Wozniak K, Klinowski J. Solid-state NMR studies of alkali metal ion complexes of p-tertbutyl-calixarenes. Chem Phys Lett 1999; 308:65-70, incorporated herein by reference in its entirety]. The maximum intensity of the pure TBC[4] is observed at 20=20.2°, while it is at 21.44° and 20.8° for Ni-TBC[4] and Co-TBC[4], respectively. At low values of 28 (i.e. 10.3° and 11.7°), the complexes are lacking some peaks while at higher angles the intensity is lower than the pure calixarene. The peak intensity of the derivatives has experienced a dramatic decrease compared to the pure p-tert-butylcalix[4]arene, owing to the complexation [Benevelli F, Kolodziejski W, Wozniak K, Klinowski J. Solid-state NMR studies of alkali metal ion complexes of p-tertbutyl-calixarenes. Chem Phys Lett 1999; 308:65-70, incorporated herein by reference in its entirety]. Moreover, the peak intensity increases with decreasing cation size, which is shown by the observation that Co-TBC[4] has an intensity decreased by 20.9% relative to the Ni-TBC[4] as the cation size of Co²⁺ is greater than Ni²⁺.

The significant differences in the XRD pattern between the formed complexes and the pure p-tert-butlycalix[4]arene arise due to the fact that the cation is relatively large compared to the size of calixarene used. As a result, a small width of the calix where the cations are contained may lower the percentage of inclusion.

### EXAMPLE 6

### Characterization of Metal-Based p-tert-butylcalix[4]arene: UV-Vis Spectroscopy

The complexation behavior of p-tert-butylcalix[4]arene with Ni²⁺ and Co²⁺ was evaluated by UV-vis spectroscopy where the absorbance was measured by JASCO V-670 UV-VIS-NIR Spectrophotometer using standard 1.00-cm quartz cells. The solvent used for analysis was ethanol and the analysis was carried out at wavelength ranging between 200 and 750 nm.

The maximum absorbance (λₘₐₓ) for free TBC[4], Co-TBC[4], and Ni-TBC[4] appear at around 302, 304, and 308 nm, respectively (FIG. 9). Although that the free ligand results in a single peak, the complexation causes the appearance of other distinguishable humps for the Ni²⁺ and Co²⁺ at 398 nm and 520 nm, respectively, due to the enhancement of n-π* electronic transitions of the carbonyl group as well as the phenoxy oxygen atoms. The complexation of Ni²⁺ and Co²⁺ is found to greatly enhance the λₘₐₓ, however, the Ni-TBC[4] shows higher maximum relative absorption intensity with 95.8% compared with the Co-TBC[4]. The spectral differences between the complexes formed indicated that the Ni²⁺ and Co²⁺ bind to the p-tert-butylcalix[4]arene at different locations [Adhikari, B. B.; Gurung, M.; Chetry, A. B.; Kawakita, H.; Ohto, K. Highly Selective and Efficient Extraction of Two Pb2+ Ions with a P-Tert-Butylcalix[6]Arene Hexacarboxylic Acid Ligand: An Allosteric Effect in Extraction. RSC Adv. 2013:3:25950-25959, incorporated herein by reference in its entirety].

### EXAMPLE 7

### Characterization of MetalBbased p-tert-butylcalix[4]arene: Inductively Coupled Plasma (ICP)

Inductively coupled plasma (ICP) analysis was performed on the metal-based calixarenes to confirm the metal content in each sample prepared. Before conducting the test, the samples were digested in nitric acid 65% (Sigma Aldrich, Germany). Ten milligrams of each sample were mixed with 5 mL of nitric acid under heating ranging from 60-70° C. until a total volume reduced to 2 mL through evaporation of excess nitric acid. Then, the digested clear solution was cooled down and its volume was raised to 30 mL by adding deionized water. After that, the solution was heated at 50° C. for 1.5 h. The solution was filtered using Millipore filter paper of 0.1 μm size to remove all remaining colloidal particles. Finally, the filtrate volume was increased to 50 mL by addition of deionized water.

After preparation of the samples, they were analyzed using PlasmaQuant® PQ 9000. The results showed that the content of Ni and Co in the Ni-TBC[4] and Co-TBC[4] complexes are 17.185 wt % and 6.215 wt %, respectively. The results showed an agreement with the energy dispersive X-ray (EDX) analysis results (ICP) in which that the nickel is present in the metalocalixarene complex at a higher content than the cobalt. Nevertheless, the ICP analysis is considered to be much accurate since it analyzes digested samples while the EDX spectroscopy is affected by the degree of homogeneity which would be impacted by changing the targeted area of analysis.

### EXAMPLE 8

### Evaluation: General Methods

The slurry phase hydrocracking of VGO was accomplished under different catalytic configurations using standalone dispersed catalyst, standalone supported catalyst, and mixed catalyst. The process was performed through varying reaction conditions including temperature (i.e. 390-450° C.), reaction time (i.e. 0.5-1 h), and concentration of the dispersed catalysts. In order to analyze the promotional effects of the catalytic configuration, discrete lumping of products performed based on distillation boiling ranges was implemented. Five lumps were considered including gases, <90° C.; naphtha, 90-221° C.; middles distillate, 221-343° C.; VGO, 343-565° C.; and coke. The gases were found by taking the difference with the fresh feed and liquid and solid product after the process while the coke was found by the coke analysis as discussed earlier. The conversion of VGO is calculated by Equation (1) as follows:

$$conversion ( wt \% ) = \frac{{W}_{{VGO}_{0}} - {W}_{VGO}}{{W}_{{VGO}_{0}}} \times 100 \qquad ( 1 )$$

where W_{VGO}_{₀} and W_{VGO} are the weight of VGO fed initially and remained after the process, respectively. The yield of a product is defined based on its weight percentage from the total effluent as follows in Equation (2):

$${Y}_{i} ( wt \% ) = \frac{{W}_{i}}{{W}_{p}} \times 100 \qquad ( 2 )$$

where Wᵢ is the weight of the product (i.e. gases, naphtha, distillate, VGO, or coke) and Wₚ is the weight of total product. A dimensionless (I) is proposed to comment on the catalytic activity where higher value of implies a better catalytic performance [Li C, Meng H, Yang T, Li J, Qin Y, Huang Y, et al. Study on catalytic performance of oil-soluble iron-nickel bimetallic catalyst in coal/oil co-processing. Fuel 2018; 219:30-6, incorporated herein by reference in its entirety]. The dimensionless catalytic activity parameter is calculated as follows:

$$I = \frac{{Y}_{naph} {Y}_{dist}}{{Y}_{VGO} {Y}_{coke} {Y}_{gas}} \times 100 \qquad ( 3 )$$

where Yₙₐₚₕ, Y_{dist}, Y_{VGO}, Y_{coke}, and Y_{gas} are the yields of naphtha, distillate, unconverted

VGO, coke, and gases, respectively.

### EXAMPLE 9

### Evaluation: Standalone Dispersed Catalysts

The synthesized Ni-TBC[4] and Co-TBC[4] as well as their analogues oil-soluble dispersed catalysts, nickel(II) 2-ethylhexanoate and cobalt(II) 2-ethylhexanoate, were tested in the autoclave batch reactor at 420° C. under hydrogen pressure of 8.5 MPa for 1 h. It is worth mentioning that metal sulfides are the active sites for the hydrogenation/dehydrogenation reactions. Hence, in situ sulfidation may take place on the leached metals from the organometallic compounds to form infinitesimally small metal sulfide crystals. The source of sulfur obliged for the catalytic activation is ascribed to the sulfuric heteroatoms found in the feedstock as shown in Table 3.

The yields of distillate and naphtha are higher although that the coke yields of Co-TBC[4] and Ni-TBC[4] are more than those evolved from hydrocracking over their oil soluble analogues ligands (FIG. 9). The results are in good agreement with previous studies [Zhang S, Liu D, Deng W, Que G. A review of slurry-phase hydrocracking heavy oil technology. Energy and Fuels 2007; 21:3057-62; and Panariti N, Del Bianco A, Del Piero G, Marchionna M, Carniti P. Petroleum residue upgrading with dispersed catalysts. Part 2. Effect of operating conditions. Appl Catal A Gen 2000; 204:215-22, each incorporated herein by reference in their entirety].

Thermal cracking of petroleum feedstocks occurs upon thermal activation to produce free radicals from C—C homolytic scissions, hydrogen rejection C—H heterolytic or homolytic scissions, and C-heteroatom bond scissions where the temperature must be ≥350° C. [Ortiz-Moreno H, Ramirez J, Sanchez-Minero F, Cuevas R, Ancheyta J. Hydrocracking of Maya crude oil in a slurry-phase batch reactor. II. Effect of catalyst load. Fuel 2014; 130:263-72; Kim S H, Kim K D, Lee H, Lee Y K. Beneficial roles of H-donors as diluent and H-shuttle for asphaltenes in catalytic upgrading of vacuum residue. Chem Eng J 2017; 314:1-10; Quitian A, Leyva C, Ramirez S, Ancheyta J. Exploratory study for the upgrading of transport properties of heavy oil by slurry-phase hydrocracking. Energy and Fuels 2015; 29:9-15, each incorporated herein by reference in their entirety]. The petroleum feedstocks contain resins stabilizing the asphaltenes. To avoid coke precipitation arises due to destabilized asphaltenes, a maximum dilution proportion in aliphatic phase as well as a minimum amount of resins must be achieved [Mousavi-Dehghani S A, Riazi M R, Vafaie-Sefti M, Mansoori G A. An analysis of methods for determination of onsets of asphaltene phase separations. J Pet Sci Eng 2004; 42:145-56; Speight J G. Petroleum asphaltenes—Part 1: Asphaltenes, resins and the structure of petroleum. Oil Gas Sci Technol 2004; 59:467-77; and Speight JG. The chemical and physical structure of petroleum: effects on recovery operations. J Pet Sci Eng 1999; 22:3-15, each incorporated herein by reference in their entirety]. The cracking of resins may take place at a higher pace than asphaltenes because of their lower aromatic nature. Accordingly, an equilibrium must be maintained between the resins and asphaltenes throughout the cracking process to avoid destabilizing asphaltenes and get optimum yields of valuable liquid products [Ortiz-Moreno H, Ramirez J, Sanchez-Minero F, Cuevas R, Ancheyta J. Hydrocracking of Maya crude oil in a slurry-phase batch reactor. II. Effect of catalyst load. Fuel 2014; 130:263-72; and Nguyen T M, Jung J, Lee C W, Cho J. Effect of asphaltene dispersion on slurry-phase hydrocracking of heavy residual hydrocarbons. Fuel 2018; 214:174-86, each incorporated herein by reference in their entirety].

Although the conversion resulted from thermal hydrocracking is sufficiently high, the lack of active metal sites causes lower low-boiling point liquid yields owing to the large coke formation. The free radicals formed lead to successive cracking (3-scission through parallel reaction pathways to produce lighter products is the form of gases as well as condensation of polynuclear aromatics hydrocarbons (PAHs) that leads to the formation coke deposition. The parallel reactions nature occurring during the cracking process causes an unavoidable coke formation even though the distribution of products is dependent on reaction conditions such as temperature and residence time [Kim S H, Kim K D, Lee H, Lee Y K. Beneficial roles of H-donors as diluent and H-shuttle for asphaltenes in catalytic upgrading of vacuum residue. Chem Eng J 2017; 314:1-10; and Quitian A, Leyva C, Ramirez S, Ancheyta J. Exploratory study for the upgrading of transport properties of heavy oil by slurry-phase hydrocracking. Energy and Fuels 2015; 29:9-15, each incorporated herein by reference in their entirety]. Therefore, the equilibrium between the reactions is important and can be controlled by promoting the hydrogen uptake that is governed by introduction of active metal sulfides [Panariti N, Del Bianco A, Del Piero G, Marchionna M, Carniti P. Petroleum residue upgrading with dispersed catalysts. Part 2. Effect of operating conditions. Appl Catal A Gen 2000; 204:215-22; Yang M-G, Nakamura I, Fujimoto K. Hydro-thermal cracking of heavy oils and its model compound. Catal Today 1998;43: 273-80; and Ancheyta J, Rana M S, Furimsky E. Hydroprocessing of heavy petroleum feeds: Tutorial. Catal Today 2005; 109:3-15, each incorporated herein by reference in their entirety].

Nevertheless, introducing the dispersed catalyst precursors, which are eventually converted in-situ into active sites of metal sulfides, will ensure an efficient hydrogen uptake of the evolved free radicals, so the β-scission reactions as well as the coke evolution would be controlled even at low concentrations of dispersed active metal sulfides [Quitian A, Leyva C, Ramirez S, Ancheyta J. Exploratory study for the upgrading of transport properties of heavy oil by slurry-phase hydrocracking. Energy and Fuels 2015; 29:9-15; and LaMarca C, Libanati C, Klein M T, Cronauer D C. Chain transfer during coal liquefaction: a model system analysis. Prepr Pap—Am Chem Soc Div Fuel Chem 1990; 35:448-54, each incorporated herein by reference in their entirety]. Also, the dispersed catalyst will act on partially hydrogenating the PAHs, which may function as a hydrogen donor that goes in the hydrogenation/dehydrogenation cycle [Gray M R, McCaffrey W C. Role of chain reactions and olefin formation in cracking, hydroconversion, and coking of petroleum and bitumen fractions. Energy and Fuels 2002; 16:756-66, incorporated herein by reference in its entirety]. The metallic wall of the reactor vessel may promote the hydrogen uptake. However, it is worth mentioning that this behavior cannot be generalized since it is only noticeable for small-scale processes [Schmidt E, Song C, Schobert H H. Hydrotreatment of 4-(1-Naphthylmethyl) bibenzyl in the Presence of Iron Catalysts and Sulfur. Energy & Fuels 1996; 10:597-602, incorporated herein by reference in its entirety].

The coke suppression during catalytic hydrocracking with dispersed catalysts has been studied well in the literature [Gray M R, McCaffrey W C. Role of chain reactions and olefin formation in cracking, hydroconversion, and coking of petroleum and bitumen fractions. Energy and Fuels 2002; 16:756-66; Wiehe I A. A phase separation kinetic model for coke formation. Prepr—Am Chem Soc Div Pet Chem 1993; 38:428-33; and Rezaei H, Ardakani S J, Smith K J. Comparison of MoS 2 catalysts prepared from mo-micelle and mo-octoate precursors for hydroconversion of cold lake vacuum residue: Catalyst activity, coke properties and catalyst recycle. Energy and Fuels 2012; 26:2768-78, each incorporated herein by reference in their entirety]. The cracking reactions of polynuclear aromatic hydrocarbons (PAHs) and other macromolecules may occur thermally. However, the active metals can help capturing the hydrogen from the vapor and release it to the liquid mixture of reactants. Upon reaction completion, the metal sulfide crystals are separated from the liquid product through deposition on the formed coke [Bdwi E A S, Ali S A, Quddus M R, Al-Bogami S A, Razzak S A, Hossain M M. Kinetics of Promotional Effects of Oil-Soluble Dispersed Metal (Mo, Co, and Fe) Catalysts on Slurry Phase Hydrocracking of Vacuum Gas Oil. Energy & Fuels 2017; 31:3132-42; and Li C, Meng H, Yang T, Li J, Qin Y, Huang Y, et al. Study on catalytic performance of oil-soluble iron-nickel bimetallic catalyst in coal/oil co-processing. Fuel 2018; 219:30-6, each incorporated herein by reference in their entirety]. The presence of dispersed metals sulfide even after completion of the process will insure an inhibition of coke formation during the cooling period where the temperature and pressure are high enough for accomplishing further cracking reactions that results in condensation of the PAHs. This fact could be extended to continuous hydrocracking processes by minimizing the fouling occurring in the piping system due to coke deposition, so the dispersed metal sulfides would be working within reactor's effluent as anti-fouling agents [Rueda N, Bacaud R, Vrinat M. Highly dispersed, nonsupported molybdenum sulfides. J Catal 1997; 169:404-6, incorporated herein by reference in its entirety].

The detailed mechanism of the hydrogen transfer is not yet established due to the complexity of the molecules involved in the petroleum heavy feedstocks. Previous studies propose that an organic molecule containing an aromatic ring may be activated on an active site while hydrogen is activated on another site. Then the activated hydrogen atom migrate to the activated aromatic molecule and adds across a double bond in a stepwise manner to saturate the bonds [Sanford E C, Steer J G, Muehlenbachs K, Gray M R. Residuum Hydrocracking with Supported and Dispersed Catalysts: Stable Hydrogen and Carbon Isotope Studies on Hydrogenation and Catalyst Deactivation. Energy and Fuels 1995; 9:928-35, incorporated herein by reference in its entirety]. However, there is no experimental proof yet to prefer this claim over other alternative mechanisms [Gray M R, McCaffrey W C. Role of chain reactions and olefin formation in cracking, hydroconversion, and coking of petroleum and bitumen fractions. Energy and Fuels 2002; 16:756-66, incorporated herein by reference in its entirety].

Experiments were conducted at different metal concentrations (i.e. 100 ppm and 500 ppm) to study their effects on the hydrocracking product distribution. FIGS. 12A and B show the product distribution for the Co-TBC[4] and Ni-TBC[4] applied at different concentrations. It has been noticed that for both catalyst precursors, increasing the concentration would proportionally increase the yield of distillate. These results show that the hydrogen uptake is concentration dependent. Although hydrogenation is enhanced by increasing the catalyst concentration to 500 ppm, the coke yields for hydrocracking over both Co-TBC[4] and Ni-TBC[4] have increased to 2.43 wt % and 2.26 wt %, respectively. This is attributed to the increase of the hydrogenation activity due to increasing metal sulfide concentration that also causes a reduction in the stability of asphaltenes. Therefore, coke precursors are activated in the form of destabilized asphaltenes to form coke deposits.

It is noticed that the Ni-TBC[4] is enhancing the conversion of VGO at higher manner compared with the Co-TBC[4] where it is at 86.17% for 100 ppm Ni and reaches up to 88.28% by increasing the concentration to 500 ppm. Also, the distillate yield is promoted increased from 36.87 wt % to reach 49.66 wt % while the yield of gases decreased from 20.48 wt % to 17.12 wt % for concentration of 100 ppm and 500 ppm, respectively.

The Ni-TBC [4] was tested further at different reaction temperatures since it showed the best yields of distillate. The process was conducted at 420° C. and 450° C. for a reaction time of one hour and H₂ pressure of 8.5 MPa with 500 ppm Ni content. The dimensionless catalytic activity factor has decreased from 2.22 to 0.85 upon increasing the reaction temperature from 420° C. to 450° C. which indicates a retreat in the catalytic performance. FIG. 13 shows the yield of products of hydrocracking of VGO when Ni-TBC[4] was used as a dispersed catalyst. It can be noticed that the catalytic effect of dispersed catalyst drops with increasing reaction temperature, which is concluded by an increasing gas yield from 16.26 wt % to 31.33 wt %, as well as a rising coke yield from 2.21 wt % to 3.56 wt %. Also, the yields of products of interest, which are the naphtha and distillate, dropped by 14.12% and 15.36%, respectively. However, a conversion of VGO of 80.69% at 450° C. was still higher than that of 72.37% observed for a lower temperature run. From this observation we could conclude that the thermal stability of the Ni-TBC[4] complex is affected by increasing the reaction temperature, which is reflected on lower yields of naphtha and distillate but increased yields of gases and coke even though the conversion of the VGO has increased.

### EXAMPLE 10

### Evaluation: Dispersed with Supported Catalysts

Co-catalytic configuration was applied by introducing the commercial presulfided first-stage hydrocracking catalyst (KC-2710) presented earlier along with the synthesized metal-bases calixarene to study its synergic effects by using it as an additive. As shown previously, the standalone dispersed catalysts, and the mixed phase catalysts were studied in the autoclave batch reactor at different reaction conditions and compared against the performance of using the unaccompanied commercial catalyst. The oil to catalyst ratio was fixed at 20:1 for all experiments conducted.

In addition to the thermal cracking of hydrocarbons, the cracking is also taking place due to the presence of acidic active sites in the supported catalysts. The solid supported catalyst that is used herein has bifunctional active sites on which the cracking reactions will take place on the Bronsted as well as the Lewis acidic sites present in the Al₂O₃—SiO₂ while the hydrogenation of carbenium ion resulted from cracking will occur with the aid of supported metal sulfides. However, the presence of dispersed metal sulfides will promote the hydrogenation of the carbenium ion resulted from the thermal cracking reaction. Also, the free metal sulfide crystals may promote the hydrotreating reactions that include hydrodesulfurization, hydrodenitrogenation, and hydrodeoxygenation, etc.

The results presented in FIG. 14 reveal that employing the presulfided supported catalyst for VGO hydrocracking has enhanced the conversion of VGO from 78.12% to 83.2% compared with the thermal hydrocracking run. Introducing the Ni-TBC[4] (500 ppm Ni) along with the supported catalyst shows satisfying catalytic hydrogenation activity that is demonstrated by increasing yields of naphtha from 15.27 wt % to 16.36 wt % and distillate from 52.17 wt % to 53.57 wt %, compared with using the supported catalyst individually at a comparable conversion of VGO at 83.20%. Additionally, the yields of coke and gases have decreased by 35.86% and 13.90%, respectively, which further verify the catalytic hydrogenation activity of the Ni-TBC[4]. The actual results of hydrocracking over mixed catalysts were compared with the results obtained by the algebraic average of the product yields after individual hydrocracking with the supported catalyst alone and the Ni-TBC[4] alone to investigate any synergistic effects between the catalysts. The dimensionless catalytic activity parameter values prove the synergy between the catalysts as it is much higher than algebraically calculated yields.

As discussed previously, with the standalone dispersed catalyst, the effect of varying the reaction temperature of the catalytic performance was investigated for the co-catalyst at different temperatures (i.e. 390° C., 420° C., and 450° C.) where VGO and supported catalyst at a ratio of 20:1 was loaded with the Ni-TBC[4] dispersed catalyst at a concentration of 500 ppm of Ni. The dimensionless catalytic activity factor was found to increase from 1.50 at 390° C. and it reached an optimum value of 2.33 at 420° C., before falls back to 2.17 as the reaction temperature was escalated to 450° C. The conversion of VGO is showing a steady and sharp increase from 68.12% to 96.07% by intensifying the reaction severity (e.g. temperature). Unlike the use of standalone dispersed catalyst, the increase of VGO conversion owing to the use of the supported catalyst is ensuring effective reactions even at higher reaction temperatures.

FIG. 15 shows that the yield of distillate reached an optimum value of 53.57 wt % when the process is operated at 420° C. This observation is illustrated in that at a lower reaction temperature (390° C.) a lower amount of metal is leached from the TBC[4], however, increasing the reaction temperature to up to 420° C. will result in a maximum amount of metal being leached. Consequently, highly dispersed metal sulfides are formed within the reactant which will also lead to reduced coke and gas yields. Nevertheless, the catalytic hydrogenation performance is dropped when the process is conducted at even higher temperature (450° C.), which may be triggered by the agglomeration of dispersed metal crystals.

Hydrocracking of VGO was conducted over supported as well as mixed (supported and dispersed) catalysts at a wide range of reaction time (e.g. 0.5, 1, and 1.5 h) at a fixed reaction temperature at 420° C. The conversion of VGO increases for both catalytic setups as the reaction time extends. Although the conversion of VGO is about 83.19% for both catalytic setups, the use of a combination of supported and dispersed catalyst gives better results in general. The fractional conversion of VGO for hydrocracking over supported catalyst alone and mixed catalysts are coinciding at ˜83.20%, as shown earlier in FIG. 14 when the reaction had been held for one hour. However, extending the reaction time to 1.5 h would favor the conversion of VGO with a yield increase of 5.24% compared with the use of standalone supported catalyst. The I-value was found to have a directly proportional relationship with the reaction time which starts from 1.85 for 0.5 h until it attains the highest value at 2.69 for a reaction time of 1.5 h.

The yield of gases produced when mixed catalysts are used is slightly higher than that using standalone supported catalysts at a short reaction time as shown in FIGS. 16A-F. Nevertheless, when the reaction time extends to 1 h and 1.5 h, the yield of gases drops to 12.32 wt % and 17.48 wt %, respectively, comparing to 14.31 wt % and 18.39 wt % for using the supported catalysts only. This observation arises due to the hydrogenation capability of the nickel sulfide crystals that is enhanced by providing a heightened dispersion capability provided by Ni-TBC[4]. The coke formation for hydrocracking using standalone supported catalyst ranges from 1.18 wt % and 1.57 wt %. However, the formation has been dramatically reduced to 0.77 wt % and 0.99 wt % for the reaction time of 0.5 h and 1.5 h, respectively. This result arises due to the consistent hydrogenation capability that is provided by the dispersed catalyst at the different reaction periods which causes the inhibition of higher percentage of coke precursors from evolving and forming coke deposits.

1: A method for hydrocracking a hydrocarbon feedstock, the method comprising:
mixing the hydrocarbon feedstock and a catalyst to form a slurry; and
heating the slurry in the presence of H₂ gas thereby forming a hydrocracked product,
wherein:
the hydrocarbon feedstock comprises C₂₀ through C₅₀ hydrocarbons and boils in a range of 300-700° C.; and
the catalyst comprises a complex comprising a transition metal ion coordinated to a calixarene ligand of formula (I) 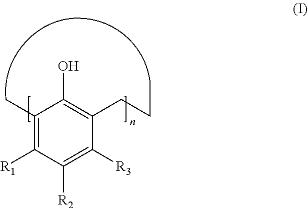
or a salt thereof, a solvate thereof, a tautomer thereof, a stereoisomer thereof, or a mixture thereof;
wherein:
R₁, R₂, and R₃ are each independently selected from the group consisting of a hydrogen, an optionally substituted alkyl, an optionally substituted cycloalkyl, an optionally substituted alkoxy, a sulfonic acid, and a hydroxy; and
n is an integer in a range of 4-8.

2: The method of claim 1, wherein the transition metal ion is an ion of at least one metal selected from the group consisting of Fe, Ni, Co, Mo, Ru, Rh, Pd, W, and Re.

3: The method of claim 2, wherein the transition metal ion is an ion of Ni, Co, or both.

4: The method of claim 1, wherein R₂ is a tert-butyl.

5: The method of claim 1, wherein R₁ and R₃ are a hydrogen.

6: The method of claim 1, wherein n is 4.

7: The method of claim 1, wherein the calixarene ligand is 4-tert-butylcalix[4]arene.

8: The method of claim 1, wherein the complex has an ultraviolet visible absorption with an absorption band in a range of 380-550 nm.

9: The method of claim 1, wherein the complex is present in the slurry at a concentration of 500-20,000 ppm.

10: The method of claim 1, wherein the hydrocarbon feedstock comprises vacuum gas oil (VGO).

11: The method of claim 1, wherein the hydrocarbon feedstock has a sulfur content of 0.5-5 wt % relative to a total weight of the hydrocarbon feedstock.

12: The method of claim 1, wherein the hydrocracked product comprises a middle distillate, a naphtha, or both.

13: The method of claim 1, wherein the slurry is heated at a temperature in a range of 350-500° C.

14: The method of claim 1, wherein the slurry is heated for 0.25-4 hours.

15: The method of claim 1, wherein a pressure of the H₂ gas is in a range of 3 to 10 MPa.

16: The method of claim 12, wherein the middle distillate is present in the hydrocracked product, and wherein a yield of the middle distillate ranges from 30-55 wt % relative to a weight of the hydrocarbon feedstock.

17: The method of claim 12, wherein the naphtha is present in the hydrocracked product, and wherein a yield of the naphtha ranges from 7-30 wt % relative to a weight of the hydrocarbon feedstock.

18: The method of claim 1, which produces coke in an amount of less than 5 wt % relative to a weight of the hydrocarbon feedstock.

19: The method of claim 1, wherein the catalyst further comprises a supported hydrocracking catalyst, and wherein a weight ratio of the supported hydrocracking catalyst to the hydrocarbon feedstock ranges from 1:5 to 1:50.

20: The method of claim 19, wherein the supported hydrocracking catalyst comprises tungsten and nickel.
